(19) United States
(12) Patent Application Publication
(10) Pub. No.: US 2024/0399939 A1
(43) Pub. Date: Dec. 5, 2024

(54) CONVEYANCE SEAT

(71) Applicant: TS TECH CO., LTD., Asaka-shi, Saitama (JP)

(72) Inventors: Akira MIYOSHI, Tochigi (JP); Tomoyuki KURIMOTO, Tochigi (JP); Keiichi KITAYAMA, Tochigi (JP)

(21) Appl. No.: 18/697,660

(22) PCT Filed: Sep. 30, 2022
(86) PCT No.: PCT/JP2022/036761

§ 371 Date: Apr. 1, 2024

Related U.S. Application Data
(60) Provisional application No. 63/261,972, filed on Oct. 1, 2021.
(60) Provisional application No. 63/263,968, filed on Nov. 12, 2021.
(60) Provisional application No. 63/285,107, filed on Dec. 2, 2021.

(51) Int. Cl. B60N 2/14; B60N 2/02; B60N 2/06

(52) U.S. Cl. CPC B60N 2/143; B60N 2/06; B60N 2002/022; B60N 2/02246; B60N 2/0252

(57) ABSTRACT

There is provided a conveyance seat that allows the slide movement and the rotational movement of a seat body to be started at appropriate timings. A conveyance seat includes a seat body in which an occupant is seated; a slide mechanism that moves the seat body in a sliding manner; a rotation mechanism that rotationally moves the seat body with an up to down direction as a rotation axis; a control unit that controls an operation of the slide mechanism and the rotation mechanism; and an operation unit that instructs the control unit to start control. When the control unit receives an instruction from the operation unit, the control unit sets a transition start time of each of the slide mechanism and the rotation mechanism.

### TECHNICAL FIELD

The present invention relates to a conveyance seat, particularly to a conveyance seat in which a seat body is movable in a sliding manner and is rotationally movable.

### BACKGROUND ART

A vehicle seat to which slide rails that allow a seat body to slide in a front to rear direction and a rotating member that rotates the seat body are attached has been known. In a vehicle seat of PATENT LITERATURE 1, the rotational movement of a seat body is motorized using an actuator.

In addition, in recent years, a seat in which the slide movement in the front to rear direction is motorized by attaching actuators to slide rails has been developed (for example, refer to PATENT LITERATURE 2).

### CITATION LIST

### Patent Literature

PATENT LITERATURE 1: JP 2020-132093 A
PATENT LITERATURE 2: WO 2020/141600

### SUMMARY OF INVENTION

### Technical Problem

However, there are few vehicle seats in which both rotational movement and slide movement are motorized, and it has been desirable to devise a control method when both rotational movement and slide movement are motorized.

The present invention has been made in view of the above-described problem, and an object of the present invention is to provide a conveyance seat that allows the slide movement and the rotational movement of a seat body to be started at appropriate timings.

### Solution to Problem

The above-described problem is solved by a conveyance seat according to the present invention including: a seat body in which an occupant is seated; a slide mechanism that moves the seat body in a sliding manner; a rotation mechanism that rotationally moves the seat body with an up to down direction as a rotation axis; a control unit that controls an operation of the slide mechanism and the rotation mechanism; and an operation unit that instructs the control section to start control, in which when the control unit receives an instruction from the operation unit, the control unit sets a transition start time of each of the slide mechanism and the rotation mechanism.

According to the present invention, the operation unit that instructs the control unit to start control is provided, and when the control unit receives an instruction from the operation unit, the control unit sets the transition start time of each of the slide mechanism and the rotation mechanism. Therefore, it is possible to provide the conveyance seat that allows the slide movement and the rotational movement of the seat body to be started at appropriate timings.

In the conveyance seat, it is preferable that the control unit is capable of causing each of the slide movable mechanism and the rotation mechanism to transition from a current state to a target state, and it is preferable that when the control unit receives the instruction from the operation unit, the control unit causes one of the slide movable mechanism and the rotation mechanism to start transitioning, and causes the other mechanism to start transitioning before the transition of the one mechanism is completed.

Since the transition of the other mechanism is started before the transition of one of the slide movable mechanism and the rotation mechanism is completed, the time required for the transition of the vehicle seat can be shortened compared to when the other transition is started after one transition is completed.

In the conveyance seat, when the control unit receives the instruction from the operation unit, it is preferable that the control unit calculates a predicted transition completion time for each of the slide movable mechanism and the rotation mechanism to transition from the current state to the target state, and sets the transition start time of the other mechanism to a time before the predicted transition completion time of the one mechanism.

By calculating the predicted transition completion time, the transition of the other mechanism can be more accurately started before the transition of the one mechanism is completed.

In the conveyance seat, when the control unit receives the instruction from the operation unit, it is preferable that the control unit causes one of the slide mechanism and the rotation mechanism to start transitioning, and causes the other mechanism to start transitioning after the transition of the one mechanism is completed.

By restricting the simultaneous transition of the slide mechanism and the rotation mechanism, the transition can be stably performed.

In addition, in the conveyance seat, when the control unit receives the instruction from the operation unit, it is preferable that a transition of the slide mechanism and a transition of the rotation mechanism are started at the same time.

By starting the transition of the slide mechanism and the transition of the rotation mechanism at the same time, the time required for the transition of the seat body can be minimized.

In addition, in the conveyance seat, it is preferable that the operation unit is a rotation lever, and it is preferable that when a rotation angle of the rotation lever is less than a predetermined angle, the control unit causes the slide mechanism to start transitioning, and when the rotation angle is greater than or equal to the predetermined angle, the control unit causes both the slide mechanism and the rotation mechanism to start transitioning.

An occupant can select and provide an instruction whether to cause only the slide mechanism or both the slide mechanism and the rotation mechanism to transition, by changing the rotation angle of the rotation lever, and can more easily move the seat body than, for example, when the occupant instructs each mechanism to transition using a plurality of buttons.

### Advantageous Effects of Invention

According to the present invention, the operation unit that instructs the control unit to start control is provided, and when the control unit receives an instruction from the operation unit, the control unit sets the transition start time of each of the slide mechanism and the rotation mechanism. Therefore, it is possible to provide the conveyance seat that allows the slide movement and the rotational movement of the seat body to be started at appropriate timings.

In addition, according to the present invention, since the transition of the other mechanism is started before the transition of one of the slide movable mechanism and the rotation mechanism is completed, the time required for the transition of the vehicle seat can be shortened compared to when the other transition is started after one transition is completed.

In addition, according to the present invention, by calculating the predicted transition completion time, the transition of the other mechanism can be more accurately started before the transition of the one mechanism is completed.

In addition, according to the present invention, by restricting s transition of the slide mechanism and the rotation mechanism, the transition can be stably performed.

According to the present invention, by starting the transition of the slide mechanism and the transition of the rotation mechanism at the same time, the time required for the transition of the seat body can be minimized.

According to the present invention, the occupant can select and provide an instruction whether to cause only the slide mechanism or both the slide mechanism and the rotation mechanism to transition, by changing the rotation angle of the rotation lever, and can more easily move the seat body than, for example, when the occupant instructs each mechanism to transition using a plurality of buttons.

### BRIEF DESCRIPTION OF DRAWINGS

FIG. 1 is a side view schematically showing a configuration of a vehicle seat according to the present embodiment.

FIG. 2 is a perspective view showing a frame of the vehicle seat.

FIG. 3 is a top view showing a rotation mechanism and a slide mechanism of the vehicle seat.

FIG. 4 is a cross-sectional view taken along line IV-IV of FIG. 3, and is a view showing configurations of the rotation mechanism and the slide mechanism.

FIG. 5 is a cross-sectional view showing the configuration of the slide mechanism.

FIG. 6A is a partially cutaway perspective view of an upper rail.

FIG. 6B is a perspective view showing meshing between screw members of the upper rail and engagement members of a lower rail.

FIG. 7A is a top view of the rotation mechanism schematically showing a positional relationship between strikers and a circumferential line of the rotation mechanism.

FIG. 7B is a top view of the rotation mechanism schematically showing another example of the positional relationship between the strikers and the circumferential line of the rotation mechanism.

FIG. 7C is a top view of the rotation mechanism schematically showing another example of the positional relationship between the strikers and the circumferential line of the rotation mechanism.

FIG. 8A is a cross-sectional view showing the slide mechanism that fixes a base member of the rotation mechanism.

FIG. 8B is a cross-sectional view showing another example of the slide mechanism that fixes the base member of the rotation mechanism.

FIG. 9 is a configuration diagram showing objects to be controlled by an ECU.

FIG. 10A is a side view schematically showing the state of the vehicle seat in a traveling mode.

FIG. 10B is a side view schematically showing the state of the vehicle seat in a leisure mode.

FIG. 11 is a description chart showing the timing that the transition of the slide mechanism and the rotation mechanism is started.

FIG. 12 is a flowchart in a case where the transition of the rotation mechanism is started before the transition of the slide mechanism is completed.

FIG. 13 is a flowchart in a case where the transition of the rotation mechanism is started after the transition of the slide mechanism is completed.

FIG. 14 is a flowchart in a case where the transition of the slide mechanism and the transition of the rotation mechanism are started at the same time.

FIG. 15 is a description view showing the rotation angle of a rotation lever.

FIG. 16 is a flowchart when the slide mechanism and the rotation mechanism are operated using the rotation lever.

FIG. 17 is a flowchart in a case where the movement speed of the vehicle seat is set depending on the orientation of the seat.

FIG. 18 is a flowchart in a case where the movement speed of the vehicle seat is set according to the rearward tilt angle of a seat back.

FIG. 19 is a side view showing another example of the vehicle seat, and is a view showing a vehicle seat that is also slidable in a right to left direction.

FIG. 20 is a top view schematically showing a configuration of a vehicle according to a second embodiment.

FIG. 21A is a cross-sectional view showing a positional relationship between a first electric power supply device and a first slide mechanism connected to a front passenger seat and a rear seat.

FIG. 21B is a cross-sectional view showing a positional relationship between the first slide mechanism connected to a center seat and the first electric power supply device.

FIG. 21C is a view showing a positional relationship between the first electric power supply device and the first slide mechanism connected to a rear seat located behind a driver seat.

FIG. 22A is a cross-sectional view showing a positional relationship between a second electric power supply device and a second slide mechanism connected to the front passenger seat and the rear seat.

FIG. 22B is a cross-sectional view showing a positional relationship between the second slide mechanism connected to the center seat and the second electric power supply device.

FIG. 22C is a cross-sectional view showing a positional relationship between the second electric power supply device and the second slide mechanism connected to the rear seat located behind the driver seat.

FIG. 23 is a schematic view showing a positional relationship between a slide mechanism and a battery of the vehicle according to a third embodiment when viewed from above.

FIG. 24 is a cross-sectional view taken along line XXIV-XXIV of FIG. 23.

FIG. 25 is a cross-sectional view showing a slide mechanism to which a separation suppression member is attached.

FIG. 26A is a top view showing a slide mechanism provided with a stopper.

FIG. 26B is a top view showing a slide mechanism provided with another seat position detection sensor.

FIG. 27 is a view showing the slide mechanism and the battery provided under a vehicle body floor.

FIG. 28 is a view showing another example of the slide mechanism and the battery provided under the vehicle body floor.

FIG. 29 is a schematic view showing a positional relationship between the slide mechanism and the vehicle (vehicle body floor) when viewed from above.

FIG. 30 is a cross-sectional view taken along line XXX-XXX of FIG. 29, and is a view showing the positional relationship between the slide mechanism and the battery.

FIG. 31 is a schematic view showing a positional relationship between the slide mechanism and a rotation seat member when viewed from above.

FIG. 32 is a cross-sectional view showing another example of the upper rail provided in a slide mechanism.

FIG. 33 is a cross-sectional view showing a sound insulation cover provided around a motor of a slide mechanism.

FIG. 34A is a cross-sectional view showing a gear cover provided around a slide mechanism.

FIG. 34B is a top view showing a part of the slide mechanism provided with the gear cover.

FIG. 35 is an exploded perspective view showing a slide mechanism and a latch mechanism.

FIG. 36 is a perspective view showing the slide mechanism to which the latch mechanism is attached.

FIG. 37 is a view showing a positional relationship between a cable casing and a blower.

### DESCRIPTION OF EMBODIMENTS

### First Embodiment

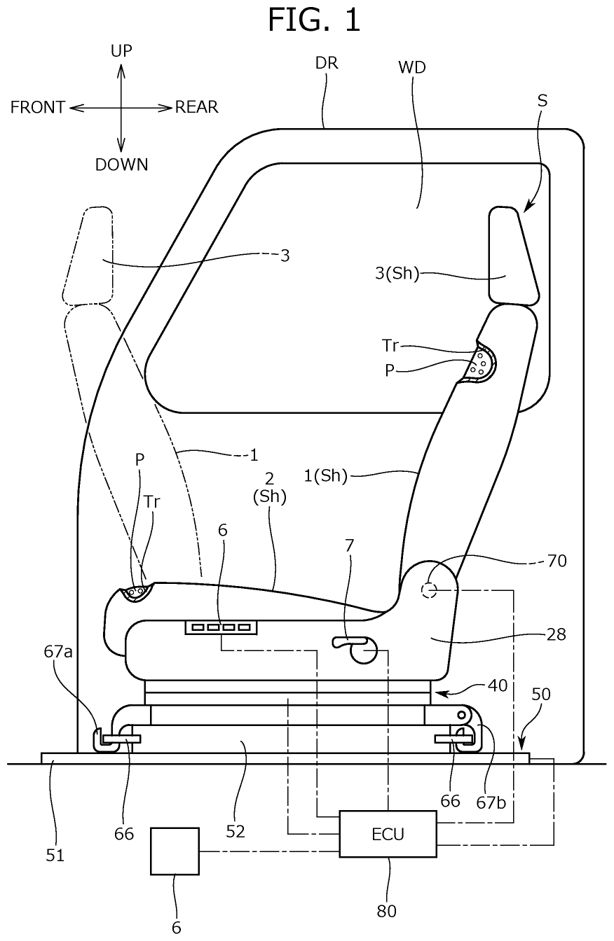

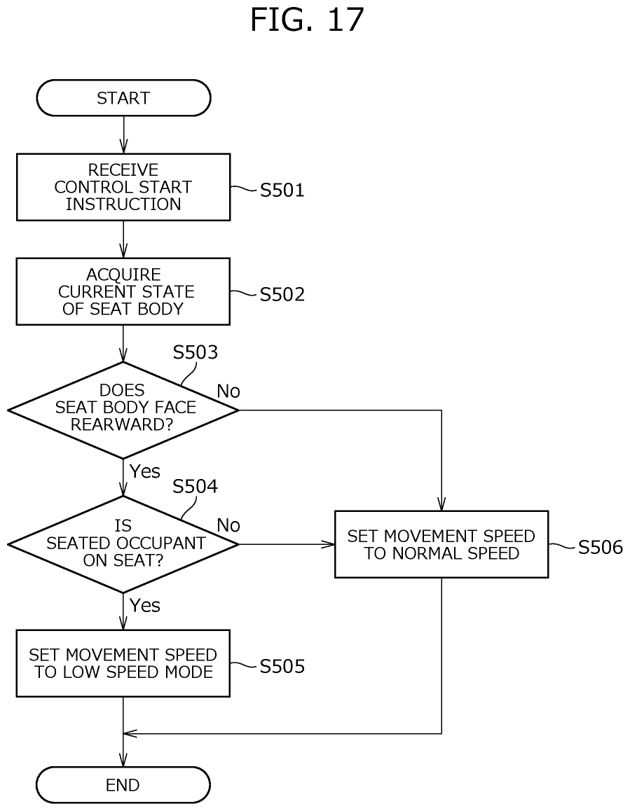

Hereinafter, a vehicle seat S according to a first embodiment of the present invention (hereinafter, referred to as the present embodiment) will be described with reference to FIGS. 1 to 19. Incidentally, the embodiment to be described below is merely one example for facilitating understanding of the present invention, and does not limit the present invention. Namely, the shapes, dimensions, dispositions, and the like of members to be described below can be changed or improved without departing from the concept of the present invention, and it goes without saying that the present invention includes equivalents thereof.

In the following description, a “front to rear direction” refers to a front to rear direction when viewed from a seated occupant of the vehicle seat S, and is a direction that coincides with a traveling direction of a vehicle. A “seat width direction” refers to a lateral width direction of the vehicle seat S, and coincides with a right to left direction when viewed from the seated occupant of the vehicle seat S.

In addition, an “up to down direction” refers to a height direction of the vehicle seat S, and coincides with an up to down direction of the vehicle seat S when viewed from the front.

### <<Configuration of Vehicle Seat S>>

First, the configuration of the vehicle seat S will be described with reference to FIGS. 1 to 8B. The vehicle seat S is a seat which is mounted in an automobile and in which an occupant can be seated.

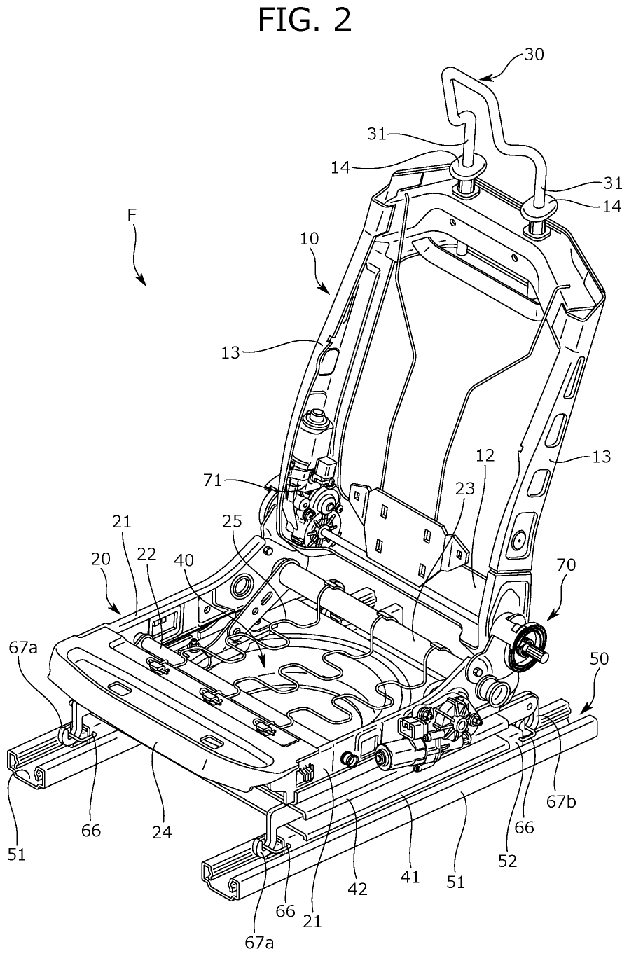

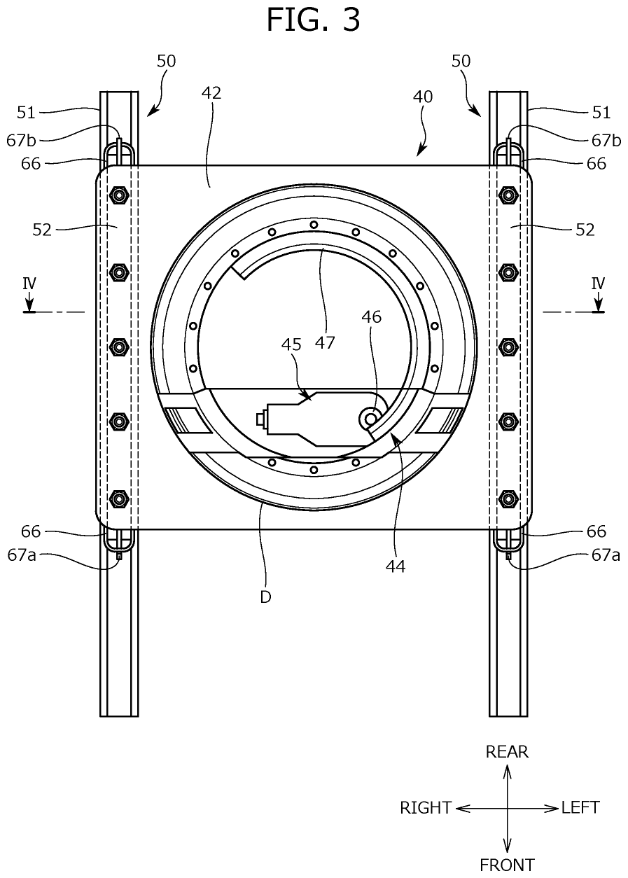

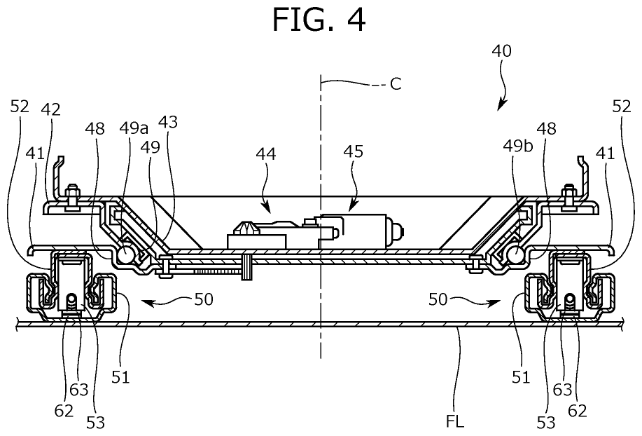

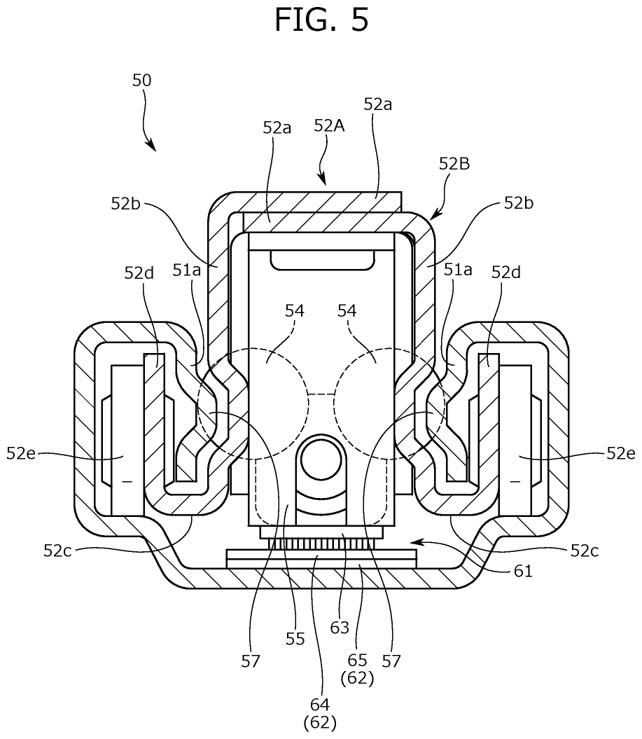

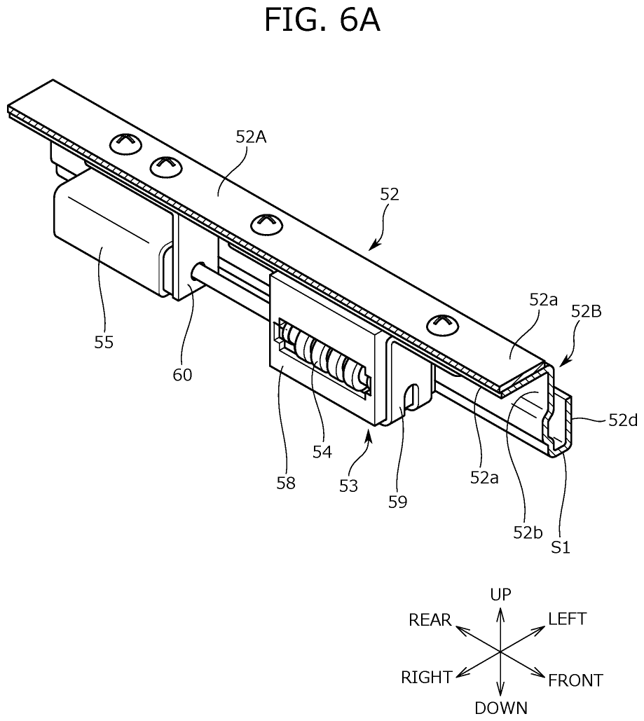

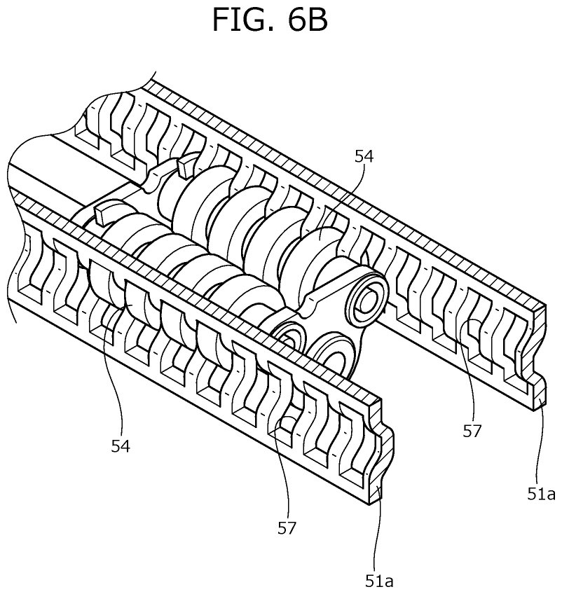

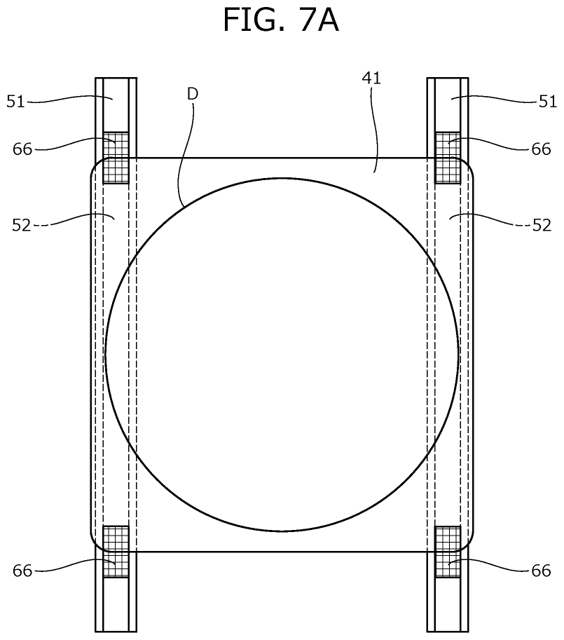

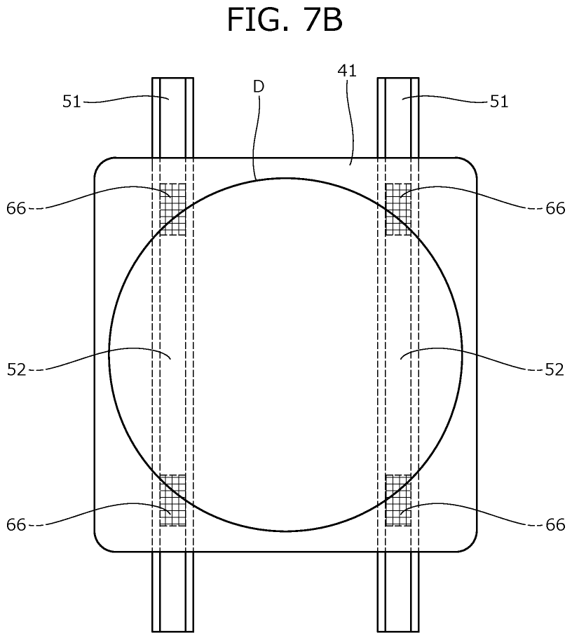

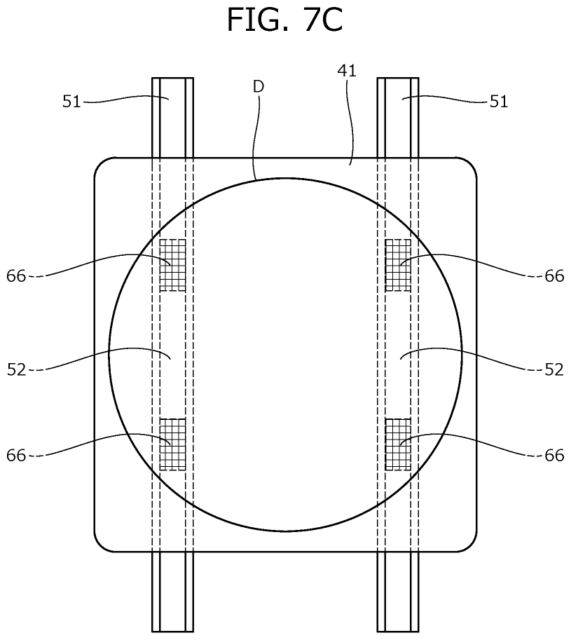

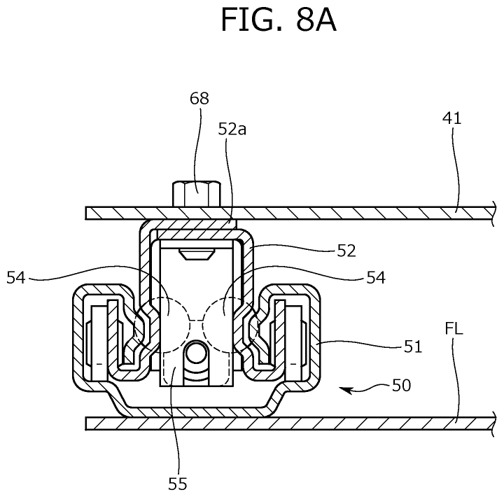

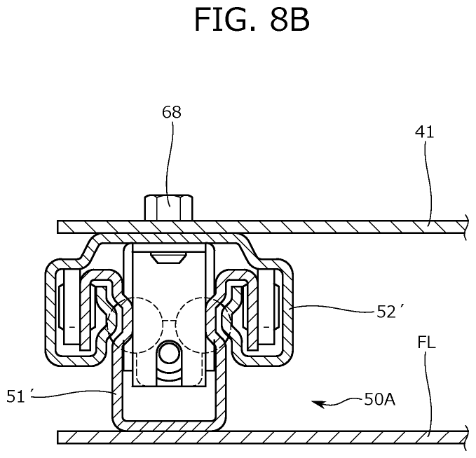

FIG. 1 schematically shows a side view of the vehicle seat S in an upright posture. In FIG. 1, for convenience of illustration, a part of the vehicle seat S is illustrated with a trim cover Tr (also referred to as a skin) removed. FIG. 2 is a perspective view of a seat frame F of the vehicle seat S. FIG. 3 is a top view showing a rotation mechanism 40, and FIG. 4 is a cross-sectional view taken along line IV-IV of FIG. 3, and is a view showing configurations of the rotation mechanism 40 and a slide mechanism 50. FIG. 5 is a cross-sectional view showing the configuration of the slide mechanism 50. FIG. 6A is a partially cutaway perspective view of an upper rail 52, and FIG. 6B is a perspective view showing meshing between worm gears 54 of the upper rail 52 and screw engagement portions 57 of a lower rail 51. FIGS. 7A to 7C are top views of the rotation mechanism 40 schematically showing a positional relationship between strikers 66 and a circumferential line of the rotation mechanism 40. FIG. 8A is a cross-sectional view showing the slide mechanism that fixes a base member of the rotation mechanism, and FIG. 8B is a cross-sectional view showing another example of the slide mechanism.

As shown in FIG. 1, the vehicle seat S includes a seat body Sh as a seat in which the occupant is seated; the rotation mechanism 40, the slide mechanism 50, and a reclining mechanism 70 that move the seat body Sh; and an electronic control unit (ECU) 80 as a control unit that controls the operation of each mechanism. In addition, a power supply 5 is provided in the vehicle, and can supply electric power to each mechanism via the ECU 80.

The seat body Sh includes a seat back 1, a seat cushion 2, a headrest 3, an operation switch 6, and a rotation lever 7 as main configurations. The seat back 1 is a backrest that supports the back of the occupant who is seated (seated occupant), from the rear. The seat cushion 2 is a seating portion that supports the buttocks of the seated occupant. The headrest 3 is a support portion that is disposed at an upper end portion of the seat back 1 and that supports the head of the seated occupant.

The seat back 1 is configured by disposing a cushion pad P on a seat back frame 10 (refer to FIG. 2) and by covering the cushion pad P with the trim cover Tr.

The seat cushion 2 is configured by placing the cushion pad P on a seat cushion frame 20 (refer to FIG. 2) and by covering the cushion pad P with the trim cover Tr. A rear end portion of the seat cushion 2 is connected to a lower end portion of the seat back 1.

In addition, the seat back 1 and the seat cushion 2 are connected to each other with the reclining mechanism 70 interposed therebetween. A rearward tilt angle G of the seat back 1 with respect to the seat cushion 2 is adjustable by the reclining mechanism 70. In addition, a reclining cover 28 that protects the reclining mechanism 70 and the like is provided at a side portion of the seat cushion 2.

As shown in FIG. 2, the seat frame F (frame) is provided in the vehicle seat S, and the seat frame F mainly includes the seat back frame 10 serving as a skeleton of the seat back 1; the seat cushion frame 20 serving as a skeleton of the seat cushion 2; and a headrest frame 30 forming a skeleton of the headrest 3.

### <Seat Back Frame 10>

As shown in FIG. 2, the seat back frame 10 is formed in a rectangular frame shape as a whole, and includes an upper frame 11, a lower frame 12, and a pair of back side frames 13 and 13. In addition, each member constituting the seat back frame 10 is formed by pressing a steel sheet.

The pair of back side frames 13 and 13 are disposed to be separated from each other in the seat width direction (right to left direction). The upper frame 11 is disposed between the pair of back side frames 13 and 13, and connects upper ends of the back side frames 13 and 13. The lower frame 12 is disposed between the pair of back side frames 13 and 13, and connects lower ends of the pair of back side frames 13 and 13.

### <Seat Cushion Frame 20>

The seat cushion frame 20 is formed in a rectangular frame shape, and a pair of cushion side frames 21 and 21 are provided at respective side portions thereof. In addition, the seat cushion frame 20 includes a front connecting frame 22 connecting the pair of cushion side frames 21 and 21 at the front, and a rear connecting frame 23 connecting the cushion side frames 21 and 21 at the rear.

The front connecting frame 22 and the rear connecting frame 23 located at the front and rear of the vehicle seat S are made of round pipes. In addition, a cushion pan frame 24 is provided in front of the front connecting frame 22. Incidentally, S springs 25 are attached to bridge between the cushion pan frame 24 and the rear connecting frame 23, and the S springs 25 serve as pressure receiving members to support the buttocks of the seated occupant from below.

Each S spring 25 is a spring formed by curving a metal wire into a zigzag shape so as to meander rightward and leftward, and the S springs 25 adjacent to each other are disposed in bilateral symmetry. Locking portions are provided at a front end portion and a rear end portion of each S spring 25, and are engaged with a rear end portion of the cushion pan frame 24 and the rear connecting frame 23. Namely, the S springs 25 are spanned between the cushion pan frame 24 and the rear connecting frame 23 of the seat cushion frame 20, and are disposed between the pair of cushion side frames 21 and 21 in a plan view.

### <Headrest 3 and Headrest Frame 30>

The headrest 3 is attached to the upper end portion of the seat back 1 to support the head of the seated occupant. As shown in FIG. 2, the headrest frame 30 forming a skeleton of the headrest 3 is provided inside the headrest 3. The headrest frame 30 includes a pair of pillar portions 31 and 31 (referred to as headrest pillars or headrest stays) disposed on the right and left. The headrest 3 is attached to the seat back frame 10 by inserting lower ends of the pillar portions 31 and 31 into headrest guides 14 attached to the upper frame 11 of the seat back frame 10.

### <Operation Switch 6>

In the present embodiment, the operation switch 6 and the rotation lever 7 are provided on the seat body Sh as operation units. More specifically, the operation switch 6 is provided on the reclining cover 28, and the rotation lever 7 is provided on a side portion of the reclining cover 28. The operation switch 6 and the rotation lever 7 are connected to the ECU 80 via cables, and the seated occupant operates the operation switch 6 or the rotation lever 7 to transmit an operation signal to the ECU 80. The ECU 80 is configured to drive the rotation mechanism 40, the slide mechanism 50, and the reclining mechanism 70 based on the received operation signal.

In addition, the operation switch 6 may be provided with not only various mechanisms that move the seat body Sh, but also a door switch for locking or unlocking a door DR of the vehicle, a window switch for opening and closing a window WD, a monitor switch for turning on and off a monitor inside the vehicle, an operation switch for operating a car navigation system, and a light switch for turning on and off a light. In addition, a wiper operation switch for operating a wiper provided in the vehicle, a rear window wiper operation switch for operating a rear window wiper, and a side window wiper operation switch for operating a side window wiper may be provided.

Since the operation switch 6 for operating various mechanisms of the vehicle seat S or devices inside the vehicle is provided, even when the seat body Sh of the vehicle seat faces rearward, the operation switch 6 is located at the same position for the seated occupant, so that the operation switch 6 can be easily operated.

### <Rotation Mechanism 40>

The vehicle seat S of the present embodiment is provided with the rotation mechanism 40 that rotates the seat body Sh with the up to down direction as an axis (rotation axis C). The rotation mechanism 40 is configured to be movable along the lower rails 51 of the slide mechanism 50 while rotatably supporting the seat body Sh.

The rotation mechanism 40 includes a base member 41 that is movable along the lower rails 51; a rotating member 42 that supports the seat frame and that is rotatably supported by the base member 41; a cover member 43 that covers a part of the rotating member 42 and that is fixed to the base member 41; and a rotation drive device 44 that rotationally moves the rotating member 42.

The rotating member 42 is rotatably supported by a rotation support portion 48 having a tubular shape included in the base member 41, via a bearing 49, and the rotation support portion 48 is formed with a substantially L-shaped transverse section.

The bearing 49 is configured such that balls 49a are held at a plurality of locations in a circumferential direction of an annular retainer, and an annular recess 49b for rolling the balls 49a is formed on the rotating member 42.

The rotating member 42 is rotationally driven by the rotation drive device 44 provided between the rotating member 42 and the base member 41, and the rotation drive device 44 includes an actuator 45; an output gear 46 rotated by rotational power exerted by the actuator 45; and an input gear 47 meshing with the output gear 46.

The actuator 45 and the output gear 46 are disposed on the rotating member 42, and the input gear 47 is fixed to the base member 41. The rotation of an electric motor inside the actuator 45 causes the rotating member 42 to rotate.

The actuator 45 is controlled by the ECU 80. In addition, by counting the number of revolutions of the motor of the actuator 45, the ECU 80 is allowed to grasp the current state of the rotation mechanism 40, for example, a rotation angle.

### <Slide Mechanism 50>

The vehicle seat S of the present embodiment is provided with the slide mechanism 50 that moves the seat body Sh in the front to rear direction in a sliding manner. The slide mechanism 50 can move the seat body Sh by sliding the upper rails 52, which support the base member 41 of the rotation mechanism 40, along the lower rails 51 in the front to rear direction. The lower rails 51 are coupled to a vehicle body floor FL. It is preferable that the slide mechanism 50 of the vehicle seat S includes a pair of the lower rails 51.

The slide mechanism 50 is a so-called electric slide rail, and includes the lower rails 51 extending in the front to rear direction, and the upper rails 52 that are received in the lower rails 51 and that slidably engage with the lower rails 51. In addition, as shown in FIG. 6A, the slide mechanism 50 includes a screw assembly 53 including the worm gears 54 that is supported by the upper rail 52 to be rotatable around the front to rear direction, and a motor 55 that is supported by the upper rail 52 and that rotates the worm gears 54. The lower rail 51 is provided with the screw engagement portions 57 extending in the front to rear direction and formed to engage with the worm gears 54.

The lower rail 51 is provided with rail inner walls 51a facing each other, and the screw engagement portions 57 are formed in the rail inner walls 51a. It is preferable that the lower rail 51 is formed by press-forming a metal sheet.

The upper rail 52 is formed by fastening a plurality of press-formed or roll-formed metal sheets. In the present embodiment, the upper rail 52 includes a first piece 52A and a second piece 52B. The first piece 52A includes a base portion 52a, a left slider inner wall 52b, a left slider lower wall 52c, and a left slider outer wall 52d. The second piece 52B includes the base portion 52a, the right slider inner wall 52b, the right slider lower wall 52c, and the right slider outer wall 52d. The upper rail 52 is formed by fastening the first piece 52A and the second piece 52B at the respective base portions 52a. Incidentally, the upper rail 52 may be formed from a single press-formed or roll-formed metal sheet.

The base portions 52a are disposed above upper walls of the right and left lower rails 51. The right and left slider inner walls 52b have surfaces facing the right and left, and face each other with a distance from each other on the right and left. The right and left slider inner walls 52b are disposed between the rail inner walls of the lower rail 51. The slider inner walls 52b face the corresponding rail inner walls on the right and left with gaps therebetween.

A plurality of wheels 52e are rotatably supported on outer surfaces of the slider outer walls 52d in the right to left direction. Each wheel 52e has a rotation axis around the right to left direction, and is in contact with a bottom wall (more specifically, an upper surface of a stepped portion) of the lower rail 51. The upper rail 52 is smoothly movable in a sliding manner with respect to the lower rail 51 by coming into contact with the lower rail 51 via the wheels 52e.

The upper rail 52 is formed in a groove shape that is open downward by the base portions 52a and the right and left slider inner walls 52b. As shown in FIG. 6A, the screw assembly 53 and the motor 55 are supported on a lower surface of the base portion 52a. The screw assembly 53 is provided with the worm gears 54 that are supported by the upper rail 52 to be rotatable around the front to rear direction. The motor 55 is configured to rotate the worm gears 54.

As shown in FIG. 6A, the screw assembly 53 includes a gear casing 58 that rotatably supports the worm gears 54, and a first bracket 59 for supporting the gear casing 58 on the upper rail 52, and openings that expose the worm gears 54 to the sides are formed in the gear casing 58. The assembly of the upper rail 52 of the screw assembly 53 can be facilitated by the gear casing 58.

In addition, a second bracket 60 that supports the motor 55 is provided behind the first bracket 59 of the upper rail 52. In the present embodiment, the second bracket 60 is configured to support an end portion on a worm gear 54 side of the motor 55 in a cantilever manner. Therefore, the motor 55 can be slightly tilted with respect to the screw assembly 53, and a core misalignment between a rotating shaft of the motor 55 and the screw assembly 53 is allowed. Incidentally, the second bracket 60 may be located in front of the first bracket 59.

As shown in FIG. 6B, the screw engagement portions 57 that extend in the front to rear direction and that engage with the worm gears 54 are formed in the lower rail 51. FIG. 6 shows only the rail inner walls 51a on the inner side of the lower rail 51. The screw engagement portions 57 include the screw engagement portion 57 formed in the left rail inner wall 51a and meshing with a screw thread of the worm gear 54, and the screw engagement portion 57 formed in the right rail inner wall 51a and meshing with a screw thread of the worm gear 54. The worm gears 54 are movable forward and rearward with respect to the screw engagement portions 57 by rotating around the front to rear direction.

Here, a structure that fixes the rotation mechanism 40 to the slide mechanism 50 will be described. In the vehicle seat S of the present embodiment, as shown in FIGS. 1 and 2, strikers 66 are provided at front ends and rear ends of the upper rails 52 of the slide mechanism 50. In addition, lock devices 67 are provided on a bottom surface of the base member 41 of the rotation mechanism 40 at positions corresponding to the strikers 66.

Each striker 66 is a member formed by bending a metal wire into a U shape in a top view. The lock devices 67 include hooks 67a that engage with the front strikers 66, and latches 67b that engage with distal end portions of the rear strikers 66. The latches 67b are configured to be rotatable, and are engaged and locked to the strikers 66 by being biased by springs, thereby fixing the seat body Sh to the vehicle body floor FL. In addition, by unlocking the latches 67b and the strikers 66 and releasing the engagement therebetween, the seat body Sh can be removed from the vehicle body floor FL. Incidentally, in the present embodiment, the hooks 67a are provided at front ends of the rotation mechanism 40; however, the latches 67b may be provided instead of the hooks 67a.

The upper rails 52 of the slide mechanism 50 are provided with the strikers 66, and the hooks 67a and the latches 67b are engaged with the base member of the rotation mechanism 40, thereby fixing the seat body Sh. Therefore, the seat body Sh can be more easily attached or removed than when fixing is performed by screwing. Therefore, the maintainability of the vehicle seat S can be improved.

The positional relationship between the strikers 66 and a circumferential line of the rotation mechanism 4 will be described using FIGS. 7A to 7C. FIGS. 7A to 7C are top views of the rotation mechanism 4 schematically showing the positional relationship between the strikers 66 and the circumferential line of the rotation mechanism 4.

As shown in FIG. 7A, the strikers 66 provided in the slide mechanism 50 of the present embodiment are disposed inside a circumferential line D of the rotation mechanism 4 in a top view. The circumferential line D is an outer peripheral portion of the rotation drive device 44 of the rotation mechanism 40.

Incidentally, as shown in FIG. 7B, the strikers 66 may be disposed on the circumference of the circumferential line D. In addition, as shown in FIG. 7C, the strikers 66 may be disposed inside the circumference of the circumferential line D.

In addition, in the present embodiment, the seat body Sh is fixed by engaging the lock devices 67 of the rotation mechanism 40 with the strikers 66 of the slide mechanism 50; however, as shown in FIG. 8A, the base member 41 of the rotation mechanism 40 may be directly attached to the upper rail 52 of the slide mechanism 50. In this case, it is preferable that the base member 41 is attached to the base portion 52a of the upper rail 52 above the worm gears 54 or the motor 55 that generate a driving force of the slide mechanism 50, and it is desirable to perform fastening using bolts 68 or the like. The attachment rigidity of the first bracket 59 and the second bracket 60 that support the worm gears 54 and the motor 55 is improved by fastening and fixing.

When the base member 41 is fastened and fixed to the base portion 52a of the upper rail 52, the first bracket 59 that attaches the worm gears 54 (more precisely, the screw assembly 53) to the upper rail 52 and the base member 41 may be fastened together. In addition, the second bracket 60 that attaches the motor 55 to the upper rail and the base member 41 may be fastened together.

In addition, the base member 41 may be attached to the base portion 52a of the upper rail 52 while avoiding the attachment positions (more specifically, fastening positions) of the first bracket 59 and the second bracket 60.

In addition, as shown in FIG. 8B, the seat body Sh may be fixed using a slide mechanism 50A in which the up-down positional relationship between the lower rail 51 and the upper rail 52 is reversed. The base member 41 of the rotation mechanism 40 is attached to an upper surface of an upper rail 52′, and a bottom surface of a lower rail 51′ is fixed to the vehicle body floor FL.

In addition, as shown in FIG. 5, the slide mechanism 50 includes an electric power supply device 61 that supplies electric power to the motor 55. The electric power supply device 61 includes an electricity transmitter 62 and an electricity receiver 63 made of a conductive contact terminal that comes into slide contact with the electricity transmitter 62.

The electricity transmitter 62 includes a conductive strip 64 connected to the power supply 5 and made of a band-shaped metal sheet extending forward and rearward inside the lower rail 51, and an electrical insulating plate 65 provided between the lower rail 51 and the conductive strip 64.

The electricity receiver 63 is provided at a lower end of the motor 55 or the gear casing 58, and extends between the motor 55 or the gear casing 58 and the conductive strip 64. The electricity receiver 63 is, for example, a metal piece having conductivity.

The electricity receiver 63 receives electric power from the electricity transmitter 62, thereby causing the motor 55 to receive a supply of electric power from the power supply 5. When the upper rail 52 moves forward and rearward with respect to the lower rail 51, the electricity receiver 63 slides forward and rearward with respect to the corresponding electricity transmitter 62, and remains in contact with the conductive strip 64 of the electricity transmitter 62.

As shown in FIG. 1, the electric power supply device 61 of the slide mechanism 50 is connected to the power supply 5 via the ECU 80. The ECU 80 is connected to the power supply 5, the electricity transmitter 62 of the slide mechanism 50, the operation switch 6, and the rotation lever 7. The operation switch 6 is provided with a button corresponding to forward movement and a button corresponding to rearward movement. In addition, a button for causing the vehicle seat S to transition to a specific state set in advance is disposed.

The ECU 80 adjusts electric power supplied to the electricity transmitter 62, based on an operation signal from the operation switch 6, to control the rotation direction and the rotation amount of the motor 55. Accordingly, the occupant can operate the operation switch 6 to drive the slide mechanism 50 to move the seat body Sh of the vehicle seat S forward and rearward with respect to the vehicle body floor FL or to cause the vehicle seat S to transition to a specific mode.

### <Reclining Mechanism 70>

The reclining mechanism 70 is a mechanism that moves (rotates) the seat back 1 such that the rearward tilt angle G of the seat back 1 is changed, and is formed of, for example, a motor 71 provided on the seat back frame 10. When the reclining mechanism 70 operates, the seat back 1 rotates around a shaft member connecting the seat back 1 and the seat cushion 2, and the seat back 1 is reclined at a predetermined rearward tilt angle G with respect to the seat cushion 2.

In addition, in the seat cushion 2 according to the present embodiment, the height of the seat cushion 2 from the vehicle body floor FL may be adjustable by a height mechanism.

Incidentally, the vehicle seat S includes various sensors and various devices in addition to the above-described configurations. For example, the vehicle seat S may include an occupant detection sensor that detects whether or not the occupant is seated, a temperature adjustment device, a lumbar support mechanism, a pressure sensor, a vibration motor, a distance sensor, and an illuminance sensor.

The operation switch 6 is an operation unit that is provided at the side portion of the seat cushion 2 of the vehicle seat S, more specifically, on an upper surface of the reclining cover 28, and that provides an instruction on a mode change of the vehicle seat S. For example, the operation switch 6 may include a first button for transforming the vehicle seat S from a traveling mode to a leisure mode, and a second button for transforming the vehicle seat S from the leisure mode to a driving mode.

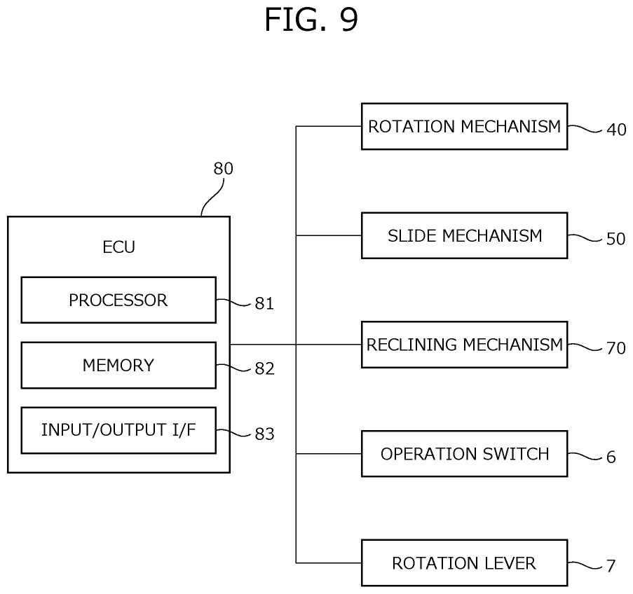

The ECU 80 is a control unit that receives operation signals from the sensors described above and the operation switch 6, and that controls each drive mechanism based on the operation signals. As shown in FIG. 9, the ECU 80 includes a processor 81, a memory 82, and an input/output interface 83.

The processor 81 is a central processing unit that executes various arithmetic processes based on programs and data stored in the memory 82, and that controls each part of the vehicle seat S.

The memory 82 is, for example, a semiconductor memory, and also functions as a work memory for the processor 81 in addition to storing various programs or data.

The input/output interface 83 communicates with devices such as the rotation mechanism 40, the slide mechanism 50, the reclining mechanism 70, the operation switch 6, the rotation lever 7, and various sensors provided in the seat. The processor 81 executes various arithmetic processes and controls each device based on signals received from each device connected thereto via the input/output interface 83.

Specifically, when the ECU 80 receives a signal related to a mode change of the vehicle seat S from the operation switch 6, the ECU 80 causes the rotation mechanism 40, the slide mechanism 50, and the reclining mechanism 70 to operate based on the signal. At this time, when the ECU 80 receives a detection signal indicating that the occupant is seated, from the occupant detection sensor, the ECU 80 may perform control to reduce the movement speed of the rotation mechanism 40 and the like.

<Regarding Operation when Vehicle Seat S is Transformed>

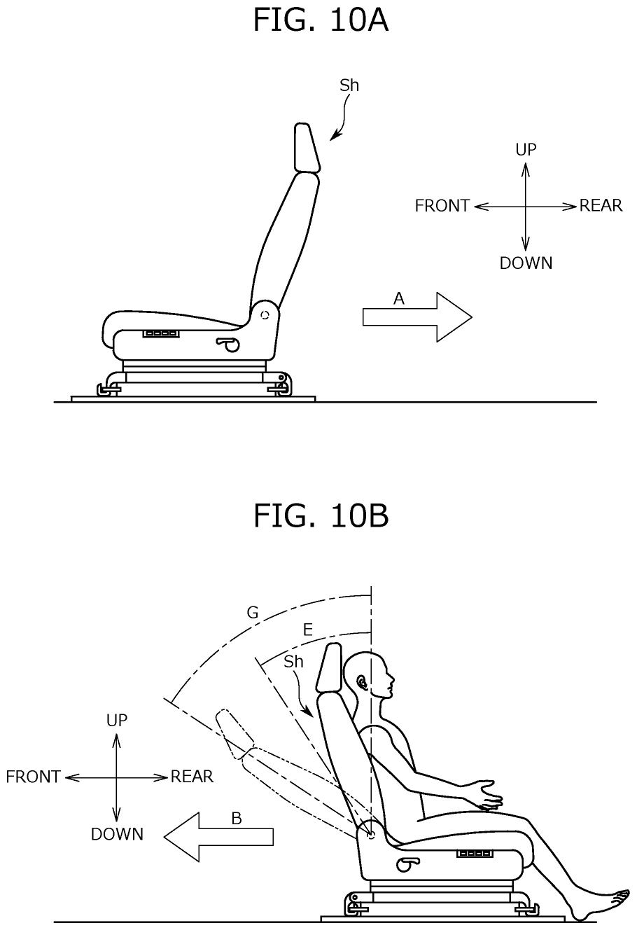

Hereinafter, details of an operation when the vehicle seat S is transformed will be described with reference to FIGS. 10A to 18.

Incidentally, in the following description, it is assumed that the vehicle seat S is transformed from the “traveling mode” to the “leisure mode”. The “traveling mode” is a mode in which, as shown in FIG. 10A, the seat body Sh of the vehicle seat S is in the upright posture and the seated occupant faces forward. The “leisure mode” is a mode in which, as shown in FIG. 10B, the seat body Sh is located at the rear and the seat body Sh faces rearward such that the seated occupant can face an occupant in a rear seat.

The memory 82 of the ECU 80 stores information on the position or the rotation angle of the vehicle seat S in each mode, and the occupant can cause the vehicle seat S to transition to each mode by operating the operation switch 6.

For example, when the vehicle seat S is at the position of the traveling mode, if the occupant inputs the operation of switching to the “leisure mode” using the operation switch 6, the ECU 80 starts the process of transitioning to the “leisure mode”.

Namely, when the occupant performs an operation for switching the vehicle seat S from the “traveling mode” that is a current state to the “leisure mode” that is a target state, the operation switch 6 receives the operation and outputs an operation signal according to the operation content. When the ECU 80 receives the operation signal from the operation switch 6, the ECU 80 is triggered upon the receipt thereof to execute a mode transition process.

Specifically, when the ECU 80 receives the operation signal from the operation switch 6, the ECU 80 executes a transition process for causing the vehicle seat to transition from the state shown in FIG. 10A to the state shown in FIG. 10B.

For example, the ECU 80 causes the slide mechanism 50 to move the seat body Sh of the vehicle seat S rearward, and causes the rotation mechanism 40 to change the orientation of the seat body Sh.

In this case, the following three patterns are considered as patterns for starting the transition of the slide mechanism 50 and the rotation mechanism 40.

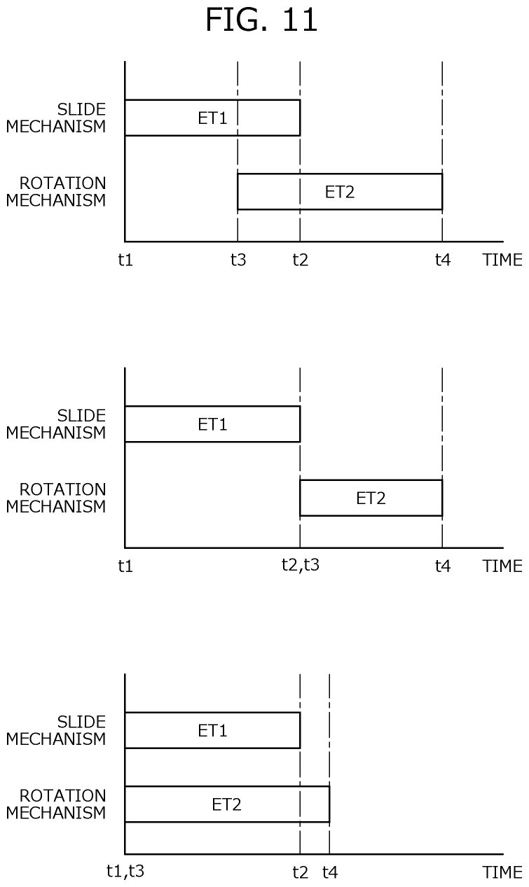

In a first pattern, as shown at the upper part of FIG. 11, first, the transition of the slide mechanism 50 is started, and the transition of the rotation mechanism 40 is started before the transition of the slide mechanism 50 is completed. In a second pattern, as shown at the middle part of FIG. 11, first, the transition of the slide mechanism 50 is started, and the transition of the rotation mechanism 40 is started after the transition of the slide mechanism 50 is completed. In a third pattern, as shown at the lower part of FIG. 11, the transition of the slide mechanism 50 and the transition of the rotation mechanism 40 are started at the same time.

Incidentally, in FIG. 11, t1 indicates a transition start time that the slide mechanism 50 starts transitioning, t2 indicates a predicted transition completion time that the transition of the slide mechanism 50 is completed, and ET1 indicates a movement time it takes for the slide mechanism 50 to transition. In addition, t3 indicates a time that the rotation mechanism 40 starts transitioning (transition start time), t4 indicates a predicted transition completion time that the transition of the rotation mechanism 40 is completed, and ET2 indicates a movement time it takes for rotation mechanism 40 to transition.

Incidentally, in the present embodiment, switching from the traveling mode to the leisure mode is realized by first performing the transition of the slide mechanism 50 as one mechanism, and then by starting the transition of the rotation mechanism 40 as the other mechanism; however, this method is one example, the switching may be realized by first starting the transition of the rotation mechanism 40 as one mechanism, and then by starting the transition of the slide mechanism 50 as the other mechanism.

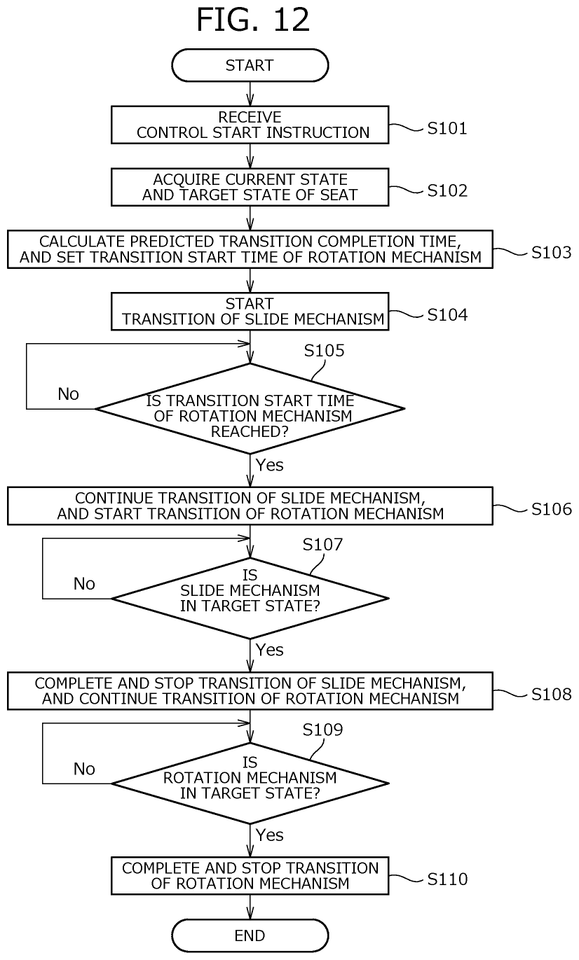

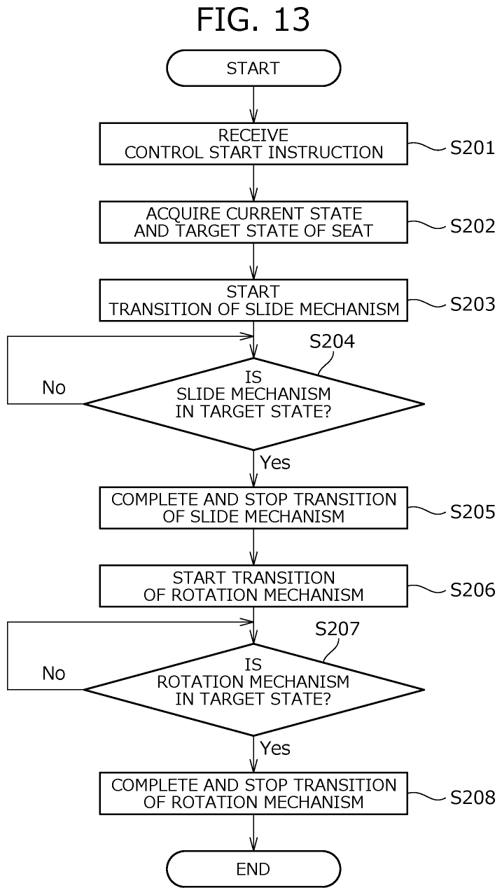

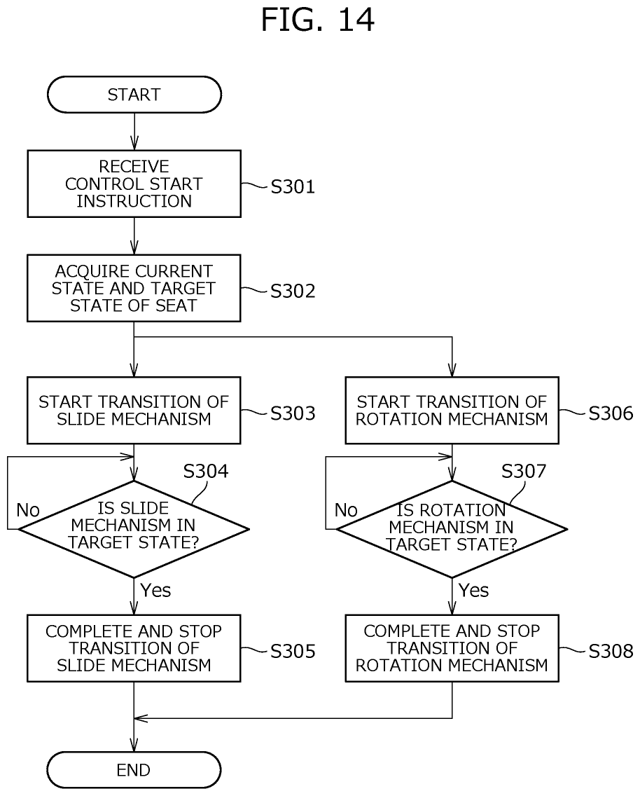

The transition process by the ECU 80 will be described using FIGS. 12 to 14. FIG. 12 is a flowchart in the case of the transition process of the first pattern, namely, in a case where the transition of the rotation mechanism 40 is started before the transition of the slide mechanism 50 is completed. FIG. 13 is a flowchart in the case of the transition process of the second pattern, namely, in a case where the transition of the rotation mechanism 40 is started after the transition of the slide mechanism 50 is completed. FIG. 14 is a flowchart in the case of the transition process of the third pattern, namely, in a case where the slide mechanism 50 and the rotation mechanism 40 start transitioning at the same time.

### <First Pattern>

In the first pattern, as shown in FIG. 12, the ECU 80 receives a control start instruction from the operation switch 6 as an operation signal. More specifically, for example, the occupant presses a leisure mode button of the operation switch to send an operation signal to the ECU 80, and the ECU 80 receives an instruction command signal (step S101).

The ECU 80 acquires the current state and the target state of the vehicle seat S (step S102). The current state of the vehicle seat S is the state of the vehicle seat S when a control start instruction is received from the operation switch 6, and the target state is the state of the vehicle seat S after the transition. When the current mode of the vehicle seat S is the “traveling mode”, the ECU 80 acquires information on the position and the rotation angle of the vehicle seat S in the “traveling mode”, which is stored in the memory 82 in advance, as information on the current state. When the target state that is a state after the transition is the “leisure mode”, the ECU 80 acquires information on the position and the rotation angle of the vehicle seat S, which is stored in the memory 82, as information on the target state.

When the current mode of the vehicle seat S is unknown, a current position and a rotation angle may be calculated from records of the number of revolutions of the motors mounted in the slide mechanism 50 and the rotation mechanism 40.

In addition, the current position of the vehicle seat S may be acquired by providing a LiDAR sensor or the like for acquiring a position in the vehicle seat S and by measuring the current position of the vehicle seat S using the sensor.

After the ECU 80 acquires the current state and the target state of the vehicle seat S, the ECU 80 calculates the predicted transition completion time t2, which is the time that the transition of the slide mechanism 50 is completed, from a distance to the target state and a set movement speed. Then, a time before a predetermined time from that time is set as the transition start time t3 of the rotation mechanism 40 (step S104).

Incidentally, when the predicted transition completion time t2 is earlier than the current time, the predetermined time is changed to a shorter time, or the transition of the rotation mechanism 40 is started in the second pattern or third pattern to be described later.

Incidentally, the transition start time t3 of the rotation mechanism 40 is set as a time before the predetermined time from the predicted transition completion time t2 of the slide mechanism 50, but may be set such that the transition of the rotation mechanism 40 is started after a predetermined time has elapsed from the start of the transition of the slide mechanism 50.

After the transition start time t3 of the rotation mechanism 40 is set, the ECU 80 causes the transition of the slide mechanism 50 to be started (step S104).

The ECU 80 constantly monitors the time and the state of the slide mechanism 50 (step S105), and when the transition start time of the rotation mechanism 40 is reached in the middle of the transition of the slide mechanism 50 (step S105: Yes), the transition of the rotation mechanism 40 is started (step S106). At this time, the slide mechanism 50 and the rotation mechanism 40 are in transition at the same time.

The ECU 80 continues to monitor the state of the slide mechanism 50 (step S107), and when it is determined that the slide mechanism is in the target state (step S107: Yes), the ECU 80 causes the slide mechanism 50 to stop to complete the transition. When the slide mechanism 50 is not in the target state (step S107: No), the process returns to step S106, and the transition of the slide mechanism 50 and the rotation mechanism 40 is continued.

In step S108, the transition of the rotation mechanism 40 is continued even after the transition of the slide mechanism 50 is completed. The ECU 80 monitors the rotation mechanism 40 (step S109), and determines whether or not the rotation mechanism 40 is in the target state. When the rotation mechanism 40 is in the target state (step S109: Yes), the transition of the rotation mechanism 40 is completed and stopped (step S119). When the rotation mechanism 40 is not in the target state (step S109: No), the transition of the rotation mechanism 40 is continued until the rotation mechanism 40 reaches the target state.

By moving the rotation mechanism 40 and the slide mechanism 50 at the same time during a part of the time, the time required to complete the transition can be shortened. In addition, since only one mechanism is moved at the start of the transition and at the completion of the transition, the mechanism can be stably operated.

### <Second Pattern>

In the second pattern, as shown in FIG. 13, the ECU 80 receives a control start instruction from the operation switch 6 (step S201).

Next, the ECU 80 acquires the current state and the target state of the vehicle seat S (step S202). Since a method for acquiring the current state and the target state is the same as in the first pattern, a detailed description will be omitted. Next, the ECU 80 causes the transition of the slide mechanism 50 to be started (step S203), and monitors the state of the slide mechanism 50. When it is determined that the slide mechanism 50 is in the target state (step S204: Yes), the ECU 80 causes the transition of the slide mechanism 50 to be completed and stopped (step S205).

Next, the ECU 80 is triggered upon the completion of the transition of the slide mechanism 50 to cause the transition of the rotation mechanism 40 to be started (step S206). The ECU 80 continues to monitor the state of the rotation mechanism 40 (step S207), and when the rotation mechanism 40 reaches the target state (step S207: Yes), the ECU 80 causes the transition of the rotation mechanism 40 to be completed and stopped (step S208).

By starting the transition of the rotation mechanism 40 after the transition of the slide mechanism 50 is completed, it takes time to complete the transition, but the operation of each mechanism can be stably performed.

### <Third Pattern>

In the third pattern, as shown in FIG. 14, the ECU 80 receives a control start instruction from the operation switch 6 (step S301). Next, the ECU 80 acquires the current state and the target state of the vehicle seat S (step S302). Since a method for acquiring the current state and the target state is the same as in the first pattern, a detailed description will be omitted.

Next, the ECU 80 causes the transition of the slide mechanism 50 and the transition of the rotation mechanism 40 to be started at the same time (step S303 and step S306). The ECU 80 monitors the transition of the slide mechanism 50 and the rotation mechanism 40 (step S304 and step S307). When the slide mechanism 50 is in the target state (step S304: Yes), the ECU 80 causes the transition of the slide mechanism 50 to be completed and stopped (step S205).

When the slide mechanism 50 is not in the target state (step S304: No), the transition of the slide mechanism 50 is continued until the slide mechanism 50 reaches the target state.

When the rotation mechanism 40 is in the target state (step S307: Yes), the transition of the rotation mechanism 40 is completed, and the transition is stopped (step S308). When the rotation mechanism 40 is not in the target state (step S307: No), the transition of the rotation mechanism 40 is continued until the rotation mechanism 40 reaches the target state.

By starting the transition of the slide mechanism 50 and the transition of the rotation mechanism 40 at the same time, the transition can be completed in the shortest time.

When the occupant operates an operation button, the transition of the vehicle seat S is executed in one of the first pattern to the third pattern. The patterns in which control is executed are stored in the memory of the ECU 80 in advance, and the ECU 80 executes control in the stored patterns. It is preferable that the occupant sets patterns, in which the movement of the mechanisms is started, in the memory 82.

### <Rotation Lever 7>

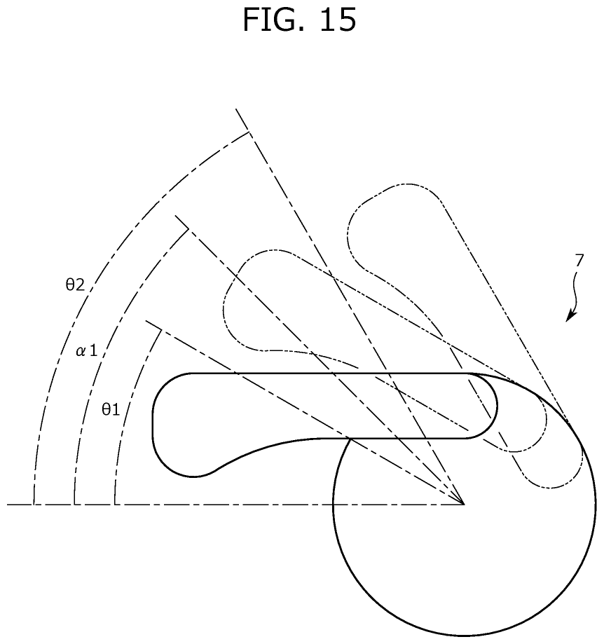

In the vehicle seat S of the present embodiment, the slide mechanism 50 or the rotation mechanism 40 can also be operated by transmitting a control start instruction signal to the ECU 80 using the rotation lever 7. More specifically, the rotation lever 7 can transmit different control start instruction signals depending on a rotation angle θ of the rotation lever 7, and for example, when the occupant rotates the rotation lever 7 at an angle less than a predetermined angle α1 (in the case of a rotation angle θ1 in FIG. 15), the rotation lever 7 can instruct only the slide mechanism 50 to transition, and when the rotation lever 7 is rotated at an angle greater than or equal to the predetermined angle α1 (in the case of a rotation angle θ2 in FIG. 15), the rotation lever 7 can instruct both the slide mechanism 50 and the rotation mechanism 40 to transition.

The occupant can stop the movement of the slide mechanism 50 or the rotation mechanism 40 by rotating the rotation lever 7 to return the rotation lever 7 to the original position, namely, setting the rotation angle θ of the rotation lever 7 to 0 degrees.

In addition, the rotation lever 7 may directly transmit information on the rotation angle θ to the ECU 80. In this case, for example, the ECU 80 can provide an instruction to cause the slide mechanism 50 to transition or to cause both the slide mechanism 50 and the rotation mechanism 40 to transition according to the received rotation angle θ.

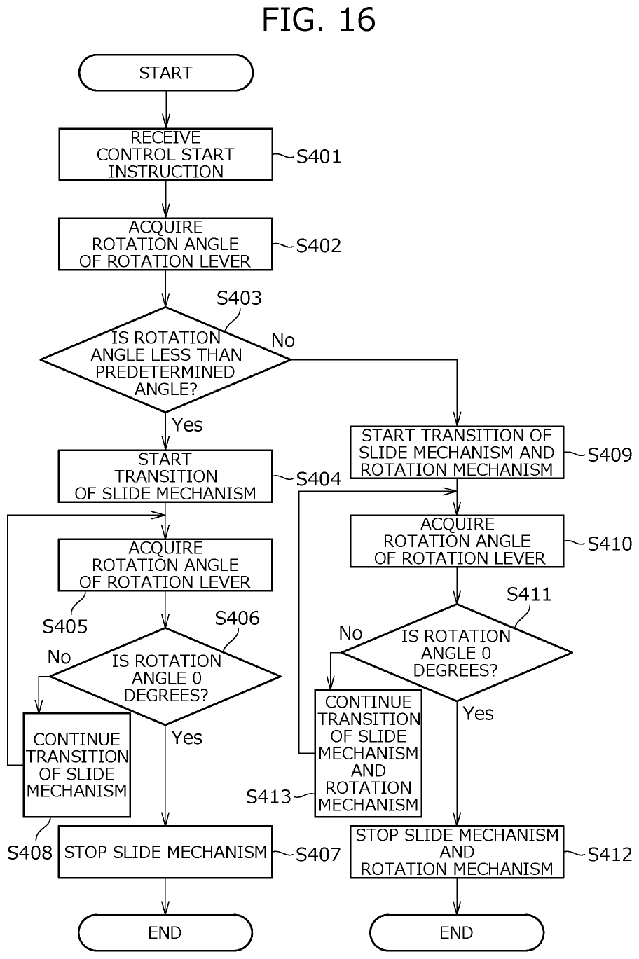

A transition process of the vehicle seat S using the rotation lever 7 will be described using FIG. 16. The ECU 80 receives a control start instruction from the rotation lever 7 (step S401). Then, information on the rotation angle θ of the rotation lever 7 is acquired. The rotation angle θ of the rotation lever 7 may be received from the rotation lever 7, or may be acquired from a sensor capable of measuring the rotation angle θ (step S402).

Next, the ECU 80 determines whether or not the rotation angle θ of the rotation lever 7 is less than the predetermined angle α1 (step S403). When the rotation angle is less than the predetermined angle α1 (step S403: Yes), only the transition of the slide mechanism 50 is started (step S404). The ECU 80 continues to acquire the rotation angle θ of the rotation lever 7 while causing the slide mechanism 50 to transition (step S405).

When the rotation angle θ is 0 degrees (step S406: Yes), the ECU 80 causes the slide mechanism 50 to stop, and ends the transition process (step S407). When the rotation angle θ is not 0 degrees (step S406: No), the transition of the slide mechanism 50 is continued (step S408). Then, the process returns to step S405, and the rotation angle θ of the rotation lever 7 is continuously acquired.

In step S403, when the rotation angle θ is not less than the predetermined angle α1 (step S403: No), namely, when the rotation angle θ is greater than or equal to the predetermined angle α1, the transition of both the slide mechanism 50 and the rotation mechanism 40 is started (step S409). The ECU 80 continues to acquire the rotation angle θ of the rotation lever 7 while causing the slide mechanism 50 and the rotation mechanism 40 to transition (step S410).

When the acquired rotation angle θ is 0 degrees (step S411: Yes), the ECU 80 causes the slide mechanism 50 and the rotation mechanism 40 to stop, and ends the transition process (step S412). When the acquired rotation angle is not 0 degrees, the process returns to step S410, and the rotation angle θ of the rotation lever 7 is acquired while causing the slide mechanism 50 and the rotation mechanism 40 to transition (step S413).

In the present embodiment, when the rotation angle θ is less than the predetermined angle α1, the slide mechanism 50 is caused to transition, and when the rotation angle θ is greater than or equal to the predetermined angle α1, both the slide mechanism 50 and the rotation mechanism 40 are caused to transition; however, this method is one example, and when the rotation angle is less than the predetermined angle α1, the rotation mechanism 40 may be caused to transition. In addition, when the rotation angle is greater than or equal to the predetermined angle α1, only the rotation mechanism 40 may be caused to transition.

When the slide mechanism 50 and the rotation mechanism 40 are operated using separate buttons, the occupant needs to press and operate a button while checking the function of the button; however, by changing the rotation angle of one rotation lever 7, both the slide mechanism 50 and the rotation mechanism 40 can be operated, so that there is no need to check a hand, which is convenient.

### <Movement Speed Change Process>

When the seat body Sh of the vehicle seat S is moved, it is preferable that the movement speed of the seat body Sh is changed depending on the state of the vehicle seat S. For example, when the orientation of the seat body and a movement direction are opposite to each other, the seated occupant may become uneasy due to being unable to check a situation in the movement direction. In this case, it is preferable that the movement speed of the seat body is set to a speed lower than a normal speed. In addition, when the seat back of the vehicle seat S is greatly tilted rearward, it is also difficult for the seated occupant to check the surrounding situation. For that reason, it is preferable that the movement speed of the seat body Sh is set to a low speed (low speed mode). On the other hand, when no occupant is seated in the vehicle seat S, it is preferable that the seat body Sh is moved as fast as possible.

For that reason, in the vehicle seat S of the present embodiment, when the ECU 80 receives a control start instruction from the operation switch 6, the ECU 80 is configured to change the movement speed of the vehicle seat S according to the current state of the vehicle seat S. For example, when the seated occupant is seated in the vehicle seat S, and the seat body Sh of the vehicle seat S faces rearward with respect to the movement direction of the seat body Sh, the ECU 80 sets the movement speed of the seat body Sh to a speed lower than the normal speed (low speed mode).

An example of the movement speed change process will be described with reference to FIG. 14. FIG. 14 is a flowchart in a case where the movement speed is changed depending on the orientation of the seat body Sh.

The ECU 80 receives a control start instruction from the operation switch 6 (step S501). At this time, the ECU 80 acquires the current state and the target state of the vehicle seat S (step S502). Since a method for acquiring the current state and the target state is the same as in step S102 shown in FIG. 12, the description will be omitted.

Next, the ECU 80 determines whether or not the seat body Sh faces rearward with respect to the movement direction thereof (step S503). When the seat body Sh faces rearward (step S503: Yes), it is determined whether or not the seated occupant is on the seat. The determination as to whether or not the seated occupant is on the seat is performed using a seating sensor or the like provided in the seat (step S504). When the seated occupant is on the seat (step S504: Yes), the slide mechanism 50 and the rotation mechanism 40 are set to transition in the low speed mode (step S505). The setting process is ended, and after step S505, the ECU 80 starts the transition process of the slide mechanism 50 or the rotation mechanism 40 at the set movement speed.

In step S503, when the seat body Sh does not face rearward with respect to the movement direction but faces in the same direction as the movement direction (step S503: No), the movement speeds of the slide mechanism 50 and the rotation mechanism 40 are set to normal speeds. In addition, in step S504, when there is no seated occupant (step S504: No), the movement speeds of the slide mechanism 50 and the rotation mechanism 40 are also set to the normal speeds. Incidentally, when no seated occupant is on the seat, the movement speeds of the slide mechanism 50 and the rotation mechanism 40 may be set to be faster than normal. Thereafter, the setting process is ended, and after step S506, the ECU 80 starts the transition process of the slide mechanism 50 or the rotation mechanism 40 at the set movement speed.

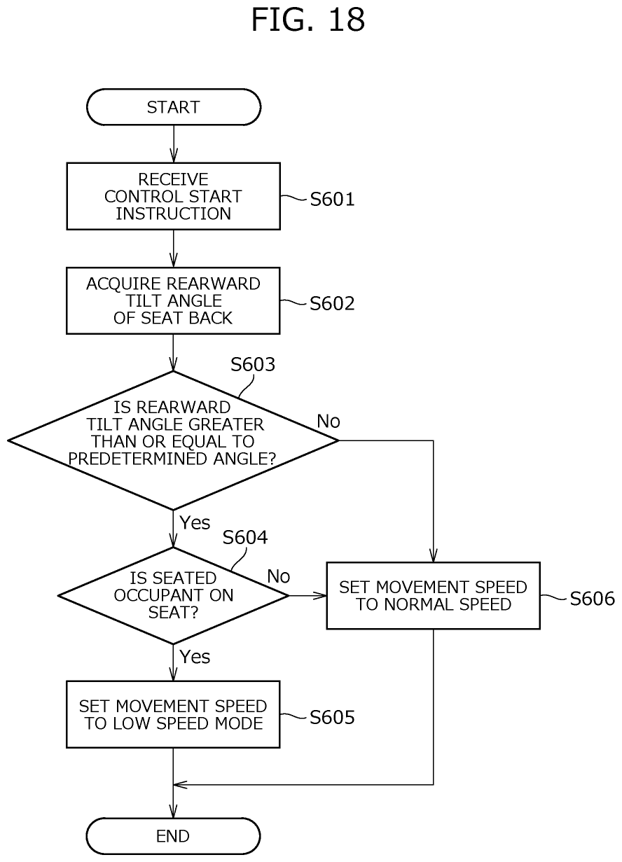

Another example of the movement speed setting process will be described with reference to FIG. 18. FIG. 18 is a flowchart in a case where the movement speed of the vehicle seat S is set according to the rearward tilt angle G of the seat back 1.

The ECU 80 receives a control start instruction from the operation switch 6 (step S601). At this time, the ECU 80 acquires the current state of the vehicle seat S (step S602). At this time, the rearward tilt angle G of the seat back is also acquired as the current state. The rearward tilt angle G is calculated, for example, from the number of revolutions of a motor when the motor drives the reclining mechanism 70. The rearward tilt angle G of the seat back 1 may be measured using, for example, a LiDAR sensor or the like.

Next, the ECU 80 determines whether or not the rearward tilt angle G of the seat back is greater than or equal to a predetermined angle E (step S603). When the rearward tilt angle G of the seat back is greater than or equal to the predetermined angle E (step S603: Yes), it is determined whether or not the seated occupant is on the seat. The determination as to whether or not the seated occupant is on the seat is performed using the seating sensor or the like provided in the seat (step S604). When the seated occupant is on the seat (step S604: Yes), the slide mechanism 50 and the rotation mechanism 40 are set to transition in the low speed mode (step S605). The ECU 80 starts the transition process of the slide mechanism 50 or the rotation mechanism 40 at the set movement speed.

In step S603, when the rearward tilt angle G of the seat body Sh is not greater than or equal to the predetermined angle E (step S603: No), the movement speed of the seat body Sh by the slide mechanism 50 and the rotation mechanism 40 is set to the normal speed. In addition, in step S604, when there is no seated occupant (step S604: No), the movement speeds of the slide mechanism 50 and the rotation mechanism 40 are also set to the normal speeds. Incidentally, when no seated occupant is on the seat, the movement speed of the seat body Sh by the slide mechanism and the rotation mechanism may be set to be faster than normal. Thereafter, the setting process is ended, and after step S606, the ECU 80 starts the transition process of the slide mechanism 50 or the rotation mechanism 40 at the set movement speed.

### <Other Configurations>

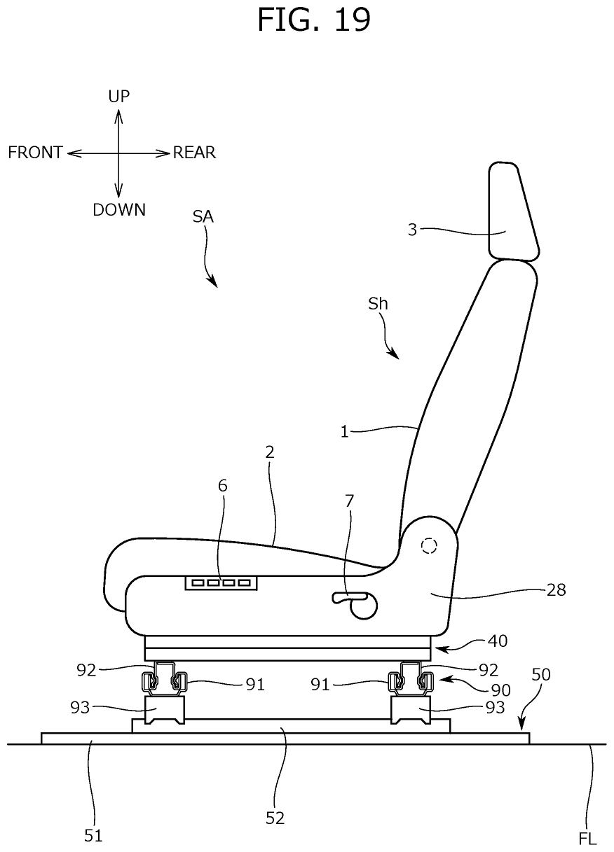

Incidentally, the vehicle seat S of the present embodiment includes the rotation mechanism 40 that rotates the seat body Sh, and the slide mechanism 50 that moves the seat body Sh in the front to rear direction; however, this configuration is one example, and the movement direction of the seat body Sh is not limited thereto. For example, as in a vehicle seat SA shown in FIG. 19, a lateral slide mechanism 90 that moves the seat body Sh in the right to left direction may be further provided between the rotation mechanism 40 and the slide mechanism 50.

The lateral slide mechanism 90 mainly includes lower rails 91; upper rails 92 that are attached to the base member 41 of the rotation mechanism 40 and that slide on the lower rails 91; and attachment brackets 93 that attach the lower rails 91 to the upper rails 52 of the slide mechanism 50.

The lower rails 91 and the upper rails 92 are installed to extend in the right to left direction (lateral direction), and the seat body Sh is movable in the right to left direction by sliding the upper rails 92.

In addition, the lateral slide mechanism 90 is electrically operated, and has the same drive mechanism as the slide mechanism 50. In addition, the lateral slide mechanism 90 is controlled by the ECU 80, and the seat body Sh is also movable in an oblique direction by cooperation between the lateral slide mechanism 90 and the slide mechanism 50 that moves the seat body Sh in the front to rear direction.

In addition, when the seat body Sh is moved in the right to left direction by the lateral slide mechanism 90, after the transition of the lateral slide mechanism 90 is started, the transition of the rotation mechanism 40 may be started before the transition of the lateral slide mechanism 90 is completed. In addition, first, the transition of the rotation mechanism 40 may be started, and the transition of the slide mechanism 90 may be started before the transition of the rotation mechanism 40 is completed.

In addition, the transition of the lateral slide mechanism 90 may be started at the same time as the rotation mechanism 40. After the transition of the lateral slide mechanism 90 is completed, the transition of the rotation mechanism 40 may be started, and after the transition of the rotation mechanism 40 is completed, the transition of the lateral slide mechanism 90 may be started.

### Second Embodiment

A vehicle V according to a second embodiment of the present invention will be described with reference to FIGS. 19 to 21C. Incidentally, the embodiment to be described below is merely one example for facilitating understanding of the present invention, and does not limit the present invention. Namely, the shapes, dimensions, dispositions, and the like of members to be described below can be changed or improved without departing from the concept of the present invention, and it goes without saying that the present invention includes equivalents thereof.

### <Configuration of Vehicle V>

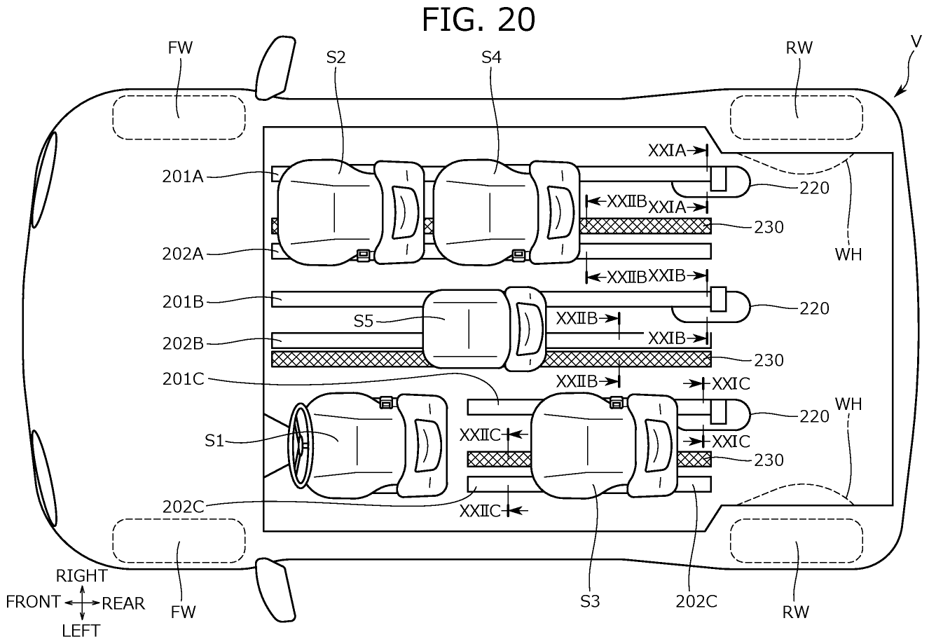

FIG. 20 is a top view schematically showing a configuration of the vehicle V, and is a view showing a positional relationship between vehicle seats S1 to S5 that are mounted and a plurality of slide mechanisms (a first slide mechanism 201A to a second slide mechanism 202B) that slide the vehicle seats in the front to rear direction.

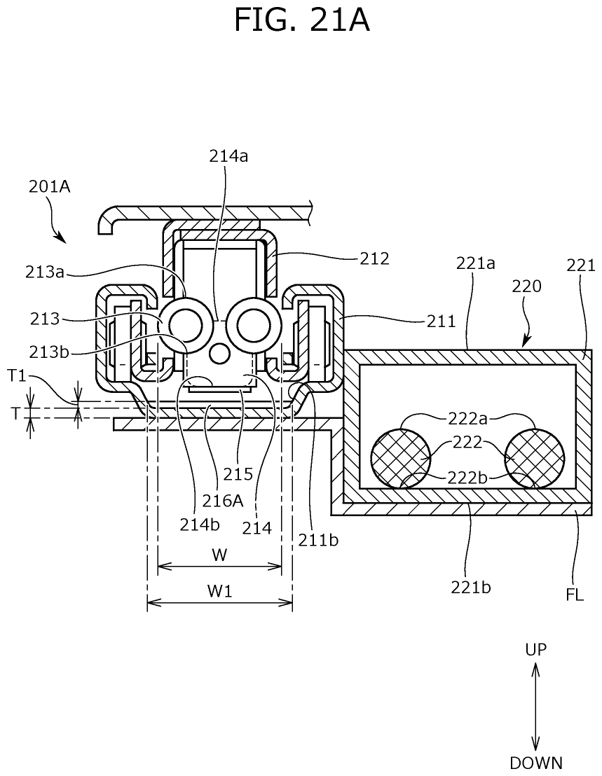

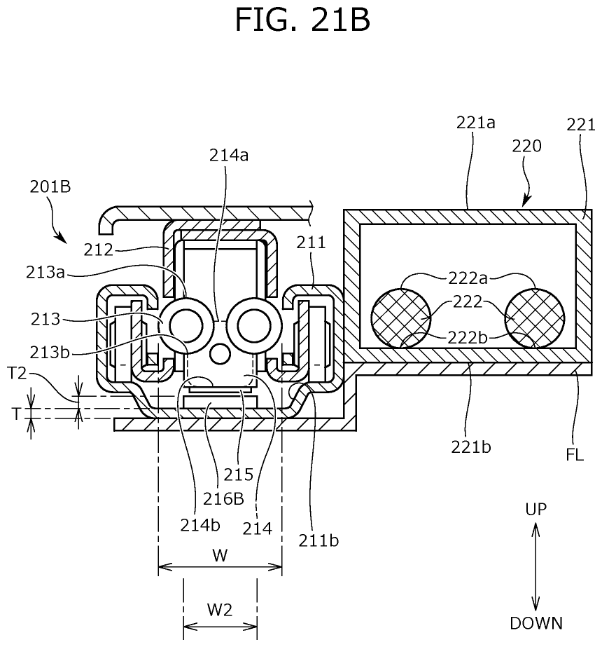

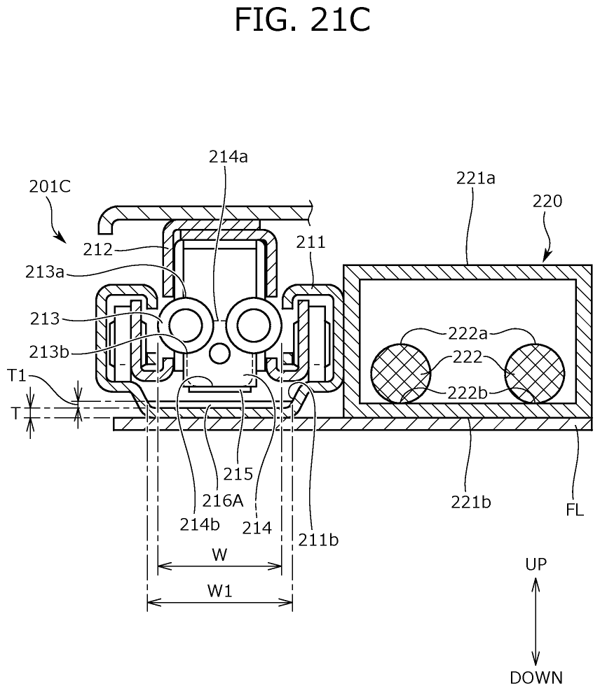

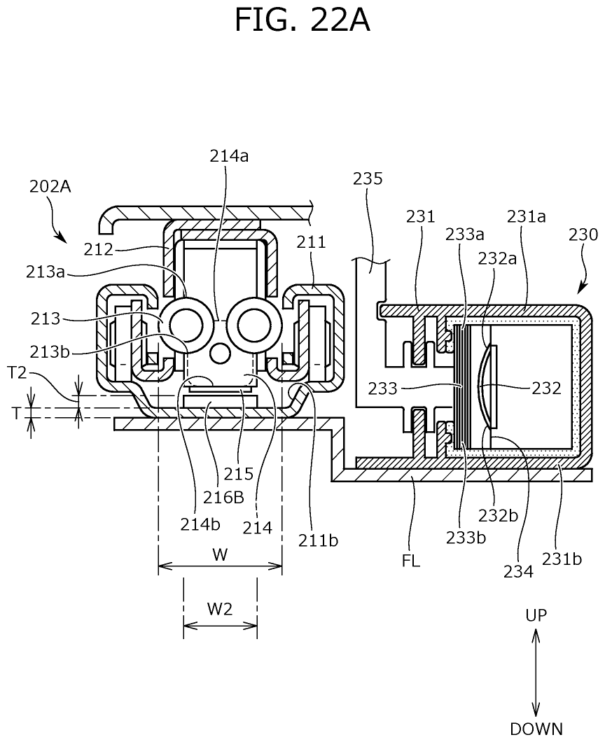

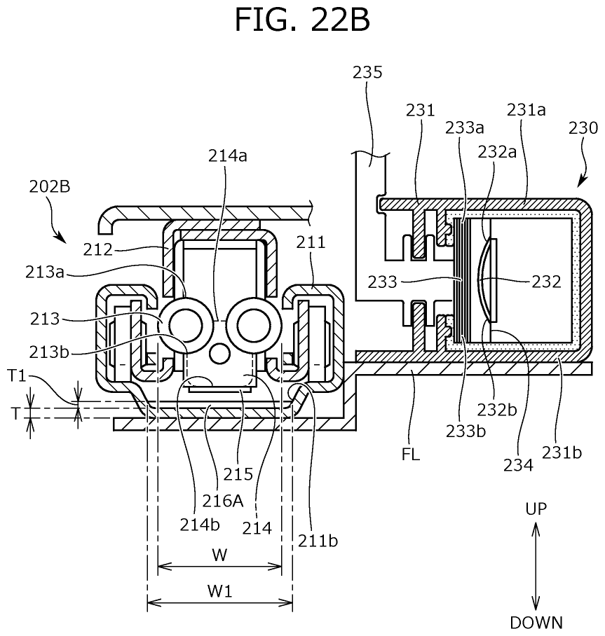

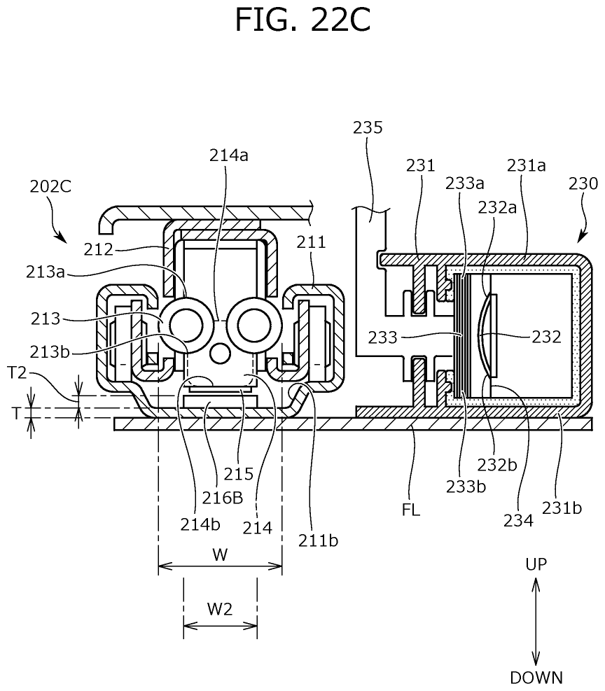

In addition, FIGS. 21A to 21C are cross-sectional views showing a positional relationship between a first slide mechanism 201 and a first electric power supply device 220, and FIGS. 22A to 22C are views showing a positional relationship between a second slide mechanism 202 and a second electric power supply device 230.

As shown in FIG. 20, the vehicle V is provided with front wheels FW at the front of the vehicle V and rear wheels RW at the rear of the vehicle V, and the rear wheels RW are stored in wheel houses WH of the vehicle V.

The driver seat S1 and the front passenger seat S2 are provided in a first row and a second row of rear seats are provided behind the driver seat S1 and the front passenger seat S2 between the front wheels FW and the rear wheels RW. The center seat S5 is provided in the second row of rear seats.

As shown in FIG. 20, a plurality of slide mechanisms 201A to 202C extending in the front to rear direction are disposed on the vehicle body floor FL of the vehicle V, and the front passenger seat S2, the rear seats S3 and S4, and the center seat S5 are movable in the front to rear direction in a sliding manner. The front passenger seat S2 and the rear seat S4 are connected to the first slide mechanism 201A and the second slide mechanism 202A, and each seat is independently movable in a sliding manner. The center seat S5 is connected to the first slide mechanism 201B and the second slide mechanism 202B, and is movable in the front to rear direction between the driver seat S1 and the front passenger seat S2 and between the rear seats S3 and S4. The rear seat S3 behind the driver seat S1 is connected to the first slide mechanism 201C and the second slide mechanism 202C, and is movable in a sliding manner.

Incidentally, in the following description, since the first slide mechanisms 201A to 201C have the same configuration except for the disposition locations, the first slide mechanisms 201A to 201C may be, unless otherwise distinguished, simply referred to as the first slide mechanism 201. In addition, similarly, the second slide mechanisms 202A to 202C may also be, unless otherwise distinguished, referred to as the second slide mechanism 202.

In addition, as shown in FIG. 20, the first electric power supply device 220 that supplies electric power to the vehicle seat S is provided at a rear end portion of the first slide mechanism 201. In addition, the second electric power supply device 230 that supplies electric power to the vehicle seat S is disposed in parallel to the second slide mechanism 202.

### <Slide Mechanism>

The first slide mechanism 201 and the second slide mechanism 202 have the same configuration as the slide mechanism 50 used in the vehicle seat S of the first embodiment. The first slide mechanism 201 and the second slide mechanism 202 include lower rails 211 attached to the vehicle body floor FL, and upper rails 212 that slide on the lower rails and that are connected to the seat body. The first slide mechanism 201 and the second slide mechanism 202 of the present embodiment are electrically operated, and each of the first slide mechanism 201 and the second slide mechanism 202 can move the seat body Sh connected thereto in a sliding manner by moving the upper rail 212 in the front to rear direction in a sliding manner through rotating two worm gears 213 using a motor 214 provided on the upper rail 212.

The motors 214 of the first slide mechanism 201 and the second slide mechanism 202 can receive electric power from an electric power supply device, and include electricity receivers 215 that receive electric power, and electricity transmitters 216A and 216B that transmit electric power to the electricity receivers 215. The electricity transmitters 216A and 216B are provided on recessed portions 211b of bottom surfaces of the respective lower rails 211. In addition, the electricity receivers 215 are attached to bottom surfaces of respective gear casing that support the worm gears 213, and are disposed to face the respective electricity transmitters 216A and 216B. Incidentally, the electricity receivers 215 may be attached to bottom surfaces of the respective motors 214.

### <First Electric Power Supply Device>

The first electric power supply device 220 is provided at a rear end portion of the first slide mechanism 201. The first electric power supply device 220 is a device that supplies electric power to, for example, a heater device (not shown) or the like provided on the seat body Sh of the vehicle seat S. The first electric power supply device 220 is an existing electric power supply device, and a detailed description of a configuration thereof will be omitted. The first electric power supply device 220 mainly includes an electric power supply cable 222 and a first cable casing 221 that accommodates the electric power supply cable 222 inside. One end of the electric power supply cable 222 is connected to the power supply 5 provided in the vehicle V. In addition, the other end of the electric power supply cable 222 is connected to the upper rails 212, and the electric power supply cable 222 is configured to also move along with the movement of the upper rails 212 such that the supply of electric power to the seat body can be continued. The electric power supply cable 222 is disposed along the outer shape of the first cable casing 221 inside the first cable casing 221, and the length extending from the first cable casing 221 is adjustable.

The positional relationship between the first slide mechanism 201 and the first electric power supply device 220 will be described using FIGS. 21A to 21C.

### <First Slide Mechanism 201A>

First, the positional relationship between the first electric power supply device 220 and the first slide mechanism 201A connected to the front passenger seat S2 and the second row seat S4 therebehind will be described. FIG. 21A is a cross-sectional view showing the positional relationship between the first electric power supply device 220 and the first slide mechanism 201A connected to the front passenger seat S2 and the second row seat S4 therebehind.

As shown in FIG. 21A, a recess into which the first cable casing 221 of the first electric power supply device 220 is inserted is formed on the vehicle body floor FL, and a bottom portion of the first cable casing 221 of the first electric power supply device 220 is configured to be located below a bottom portion of the first slide mechanism 201A.

The worm gears 213 of the first slide mechanism 201A are disposed above the first cable casing 221 of the first electric power supply device 220.

Lower ends 213b of the worm gears 213 are disposed above an upper end 221a of the first cable casing 221.

The lower ends 223a of the worm gears 213 are disposed above an upper end 222a of the electric power supply cable 222 disposed inside the first cable casing 221.

An upper end 214a of the motor 214 (indicated by a dotted line in FIG. 21A) of the first slide mechanism 201A is disposed above the upper end of the first cable casing 221.

A lower end 214b of the motor 214 is disposed below the upper end of the first cable casing 221.

The lower end 214b of the motor 214 is disposed above the upper end 222a of the electric power supply cable 222 disposed inside the first cable casing 221.

In addition, as described above, the electricity transmitter 216A is disposed on the recessed portion 211b formed on the bottom surface of the lower rail 211. A lateral width W1 of the electricity transmitter 216A is formed to be wider than a combined lateral width W of the motor 214 and two worm gears 213. A thickness T1 of the electricity transmitter 216A is formed to be thinner than a thickness T of a sheet material forming the lower rail 211.

### <First Slide Mechanism 201B>

Next, the positional relationship between the first slide mechanism 201B connected to the center seat S5 and the first electric power supply device 220 will be described. FIG. 21B is a cross-sectional view showing the positional relationship between the first slide mechanism 201B and the first electric power supply device 220.

As shown in FIG. 21B, a protrusion on which the first cable casing 221 of the first electric power supply device 220 is placed is formed on the vehicle body floor FL, and the bottom portion of the first cable casing 221 of the first electric power supply device 220 is configured to be located above a bottom portion of the first slide mechanism 201B.

The worm gears 213 of the first slide mechanism 201B are disposed below the first cable casing 221 of the first electric power supply device 220.

The lower ends 213b of the worm gears 213 are disposed below the upper end 221a of the first cable casing 221.

The lower ends 213b of the worm gears 213 are disposed below the upper end 222a of the electric power supply cable 222 disposed inside the first cable casing 221.

The upper end 214a of the motor 214 (indicated by a dotted line in FIG. 21B) of the first slide mechanism 201B is disposed below the upper end 221a of the first cable casing 221.

The lower end 214b of the motor 214 is disposed below a lower end 221b of the first cable casing 221.

The lower end 214b of the motor 214 is disposed above the upper end 222a of the electric power supply cable 222 disposed inside the first cable casing 221.

In addition, as described above, the electricity transmitter 216B is disposed on the recessed portion 211b formed on the bottom surface of the lower rail 211. A lateral width W2 of the electricity transmitter 216B is formed to be narrower than the combined lateral width W of the motor 214 and two worm gears 213. A thickness T2 of the electricity transmitter 216B is formed to be thicker than the thickness T of the sheet material forming the lower rail 211.

### <First Slide Mechanism 201C>

Next, the positional relationship between the first slide mechanism 201C connected to the second row seat S3 located behind the driver seat S1 and the first electric power supply device 220 will be described. FIG. 21C is a cross-sectional view showing the positional relationship between the first slide mechanism 201C and the first electric power supply device 220.

As shown in FIG. 21C, the first slide mechanism 201C and the first electric power supply device 220 are placed on the vehicle body floor FL that is flush, and a bottom portion of the first slide mechanism 201C and the bottom portion of the first cable casing 221 of the first electric power supply device 220 are configured to be at the same height.

The worm gears 213 of the first slide mechanism 201C are disposed at the same position in the up to down direction as the first cable casing 221 of the first electric power supply device 220.

The lower ends 213b of the worm gears 213 are disposed below the upper end 221a of the first cable casing 221.

The lower ends 213b of the worm gears 213 are disposed above the upper end 222a of the electric power supply cable 222 disposed inside the first cable casing 221.

The upper end 214a of the motor 214 (indicated by a dotted line in FIG. 21C) of the first slide mechanism 201C is disposed below the upper end of the first cable casing 221.

The lower end 214b of the motor 214 is disposed above the lower end 221b of the first cable casing 221.

The lower end 214b of the motor 214 is disposed above a lower end 222b of the electric power supply cable 222 disposed inside the first cable casing 221.

In addition, as described above, the electricity transmitter 216A is disposed on the recessed portion 211b formed on the bottom surface of the lower rail 211. The lateral width W1 of the electricity transmitter 216A is formed to be wider than the combined lateral width W of the motor 214 and two worm gears 213. The thickness T1 of the electricity transmitter 216A is formed to be thinner than the thickness T of the sheet material forming the lower rail 211.

### <Second Electric Power Supply Device 230>

The second electric power supply device 230 is provided in parallel to the second slide mechanism 202. The second electric power supply device 230 is, for example, an electric power supply rail that supplies electric power to a reclining actuator provided on the seat body Sh. The second electric power supply device 230 includes a second cable casing 231 having a long cylindrical shape; a rail 234 laid inside the second cable casing 231; and a flexible flat cable 233 accommodated in the rail 234 inside the second cable casing 231. In addition, the second electric power supply device 230 includes a fixed terminal (not shown) fixed to the second cable casing 231; a movable terminal (not shown) that is movable in a longitudinal direction of the second cable casing 231; and an actuator 235 that stores the movable terminal, and that moves along a slit formed in the casing. A guide plate 232 that guides the movement of the flexible flat cable 233 while pressing the flexible flat cable 233 using a spring force in response to the movement of the actuator 235 is provided on an inner surface of the second cable casing 231.

### <Second Slide Mechanism 202A>

The positional relationship between the second electric power supply device 230 and the second slide mechanism 202A connected to the front passenger seat S2 and the second row seat S4 therebehind will be described. FIG. 22A is s a cross-sectional view showing the positional relationship between the second electric power supply device 230 and the second slide mechanism 202A connected to the front passenger seat S2 and the second row seat S4 therebehind.

As shown in FIG. 22A, a recess into which the second cable casing 231 of the second electric power supply device 230 is inserted is formed on the vehicle body floor FL, and a bottom portion of the second cable casing 231 of the second electric power supply device 230 is configured to be located below a bottom portion of the second slide mechanism 202A.

Upper ends 213a of the worm gears 213 of the second slide mechanism 202A are disposed above an upper end 231a of the second cable casing 231 of the second electric power supply device 230.

The lower ends 213b of the worm gears 213 are disposed below the upper end 231a of the second cable casing 231.

The lower ends 213b of the worm gears 213 are disposed above a lower end 233b of the flexible flat cable 233 disposed inside the second cable casing 231.

The lower ends 213b of the worm gears 213 are disposed above an upper end 232a of the guide plate 232.

The upper end 214a of the motor 214 (indicated by a dotted line in FIG. 22A) of the second slide mechanism 202A is disposed below the upper end 231a of the second cable casing 231.

The lower end 214b of the motor 214 is disposed below the upper end 231a of the second cable casing 231.

The lower end 214b of the motor 214 is disposed below the lower end 233b of the flexible flat cable 233 disposed inside the second cable casing 231.

In addition, as described above, the electricity transmitter 216B is disposed on the recessed portion 211b formed on the bottom surface of the lower rail 211 of the second slide mechanism 202A. The lateral width W2 of the electricity transmitter 216B is formed to be narrower than the combined lateral width W of the motor 214 and two worm gears 213. The thickness T2 of the electricity transmitter 216B is formed to be thicker than the thickness T of the sheet material forming the lower rail 211.

### <Second Slide Mechanism 202B>

The positional relationship between the second slide mechanism 202B connected to the center seat S5 and the second electric power supply device 230 will be described. FIG. 22B is a cross-sectional view showing the positional relationship between the second slide mechanism 202B connected to the center seat S5 and the second electric power supply device 230.

As shown in FIG. 22B, a protrusion on which the second cable casing 231 of the second electric power supply device 230 is placed is formed on the vehicle body floor FL, and the bottom portion of the second cable casing 231 of the second electric power supply device 230 is configured to be located above a bottom portion of the second slide mechanism 202B.

The upper ends 213a of the worm gears 213 of the second slide mechanism 202B are disposed below the upper end 231a of the second cable casing 231 of the second electric power supply device 230.

The lower ends 213b of the worm gears 213 are disposed above a lower end 231b of the second cable casing 231.

The lower ends 213b of the worm gears 213 are disposed below the lower end 233b of the flexible flat cable 233 disposed inside the second cable casing 231.

The lower ends 213b of the worm gears 213 are disposed below a lower end 232b of the guide plate 232.

The upper end 214a of the motor 214 (indicated by a dotted line in FIG. 22B) of the second slide mechanism 202B is disposed above the lower end 231b of the second cable casing 231.

The lower end 214b of the motor 214 is disposed below the lower end 231b of the second cable casing 231.

The lower end 214b of the motor 214 is disposed below the lower end 233b of the flexible flat cable 233 disposed inside the second cable casing 231.

In addition, as described above, the electricity transmitter 216A is disposed on the recessed portion 211b formed on the bottom surface of the lower rail 211 of the second slide mechanism 202B. The lateral width W1 of the electricity transmitter 216A is formed to be wider than the combined lateral width W of the motor 214 and two worm gears 213. The thickness T1 of the electricity transmitter 216A is formed to be thinner than the thickness T of the sheet material forming the lower rail 211 of the second slide mechanism 202B.

### <Second Slide Mechanism 202C>

Next, the positional relationship between the second slide mechanism 202C connected to the second row seat S3 located behind the driver seat S1 and the second electric power supply device 230 will be described. FIG. 22C is a cross-sectional view showing the positional relationship between the second slide mechanism 202C and the second electric power supply device 230.

As shown in FIG. 22C, the second slide mechanism 202C and the second electric power supply device 230 are placed on the vehicle body floor FL that is flush, and a bottom portion of the second slide mechanism 202C and the bottom portion of the second cable casing 231 of the second electric power supply device 230 are configured to be at the same height.

The upper ends 213a of the worm gears 213 of the second slide mechanism 202C are disposed below the upper end 231a of the second cable casing 231 of the second electric power supply device 230.

The lower ends 213b of the worm gears 213 are disposed above the lower end 231b of the second cable casing 231.

The worm gears 213 are disposed at the same height as the flexible flat cable 233 disposed inside the second cable casing 231.

The lower ends 213b of the worm gears 213 are disposed above the lower end 232b of the guide plate 232.

The upper end 214a of the motor 214 (indicated by a dotted line in FIG. 22C) of the second slide mechanism 202C is disposed above lower end 231b of the second cable casing 231.

The lower end 214b of the motor 214 is disposed above the lower end 231b of the second cable casing 231.

The lower end 214b of the motor 214 is disposed above the lower end 233b of the flexible flat cable 233 disposed inside the second cable casing 231.

In addition, as described above, the electricity transmitter 216B is disposed on the recessed portion 211b formed on the bottom surface of the lower rail 211 of the second slide mechanism 202C. The lateral width W2 of the electricity transmitter 216B is formed to be narrower than the combined lateral width W of the motor 214 and two worm gears 213. The thickness T2 of the electricity transmitter 216B is formed to be thicker than the thickness T of the sheet material forming the lower rail 211.

### Third Embodiment

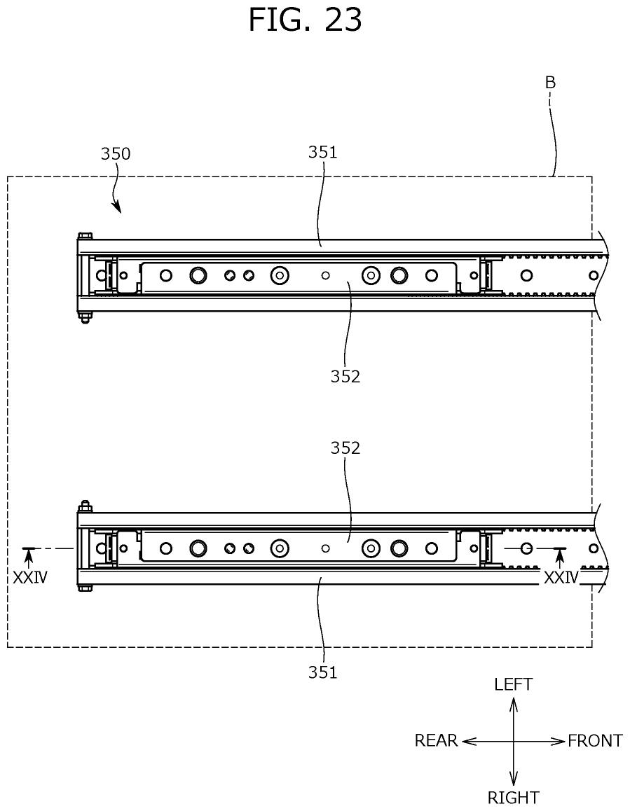

Hereinafter, an electric slide mechanism 350 mounted on the vehicle seat S according to a third embodiment of the present invention will be described with reference to FIGS. 23 to 37.

### <Positional Relationship Between Slide Mechanism and Battery>

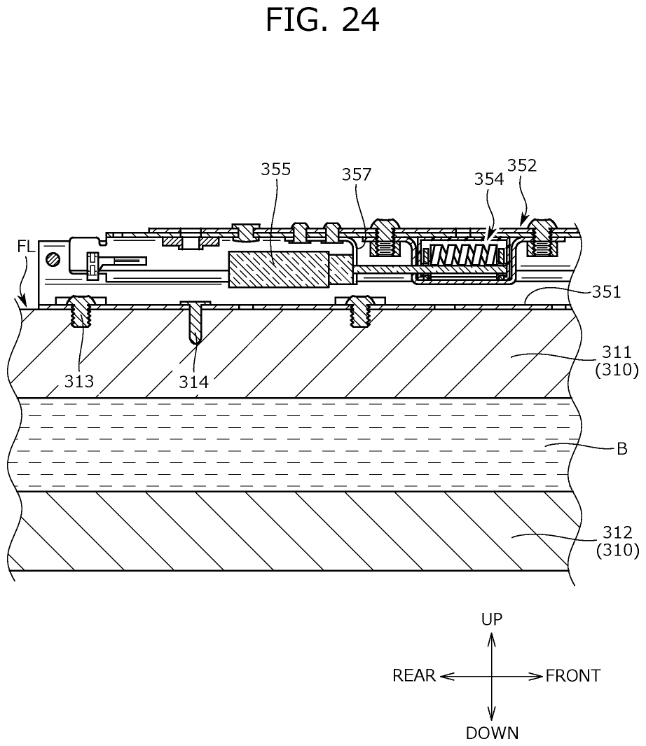

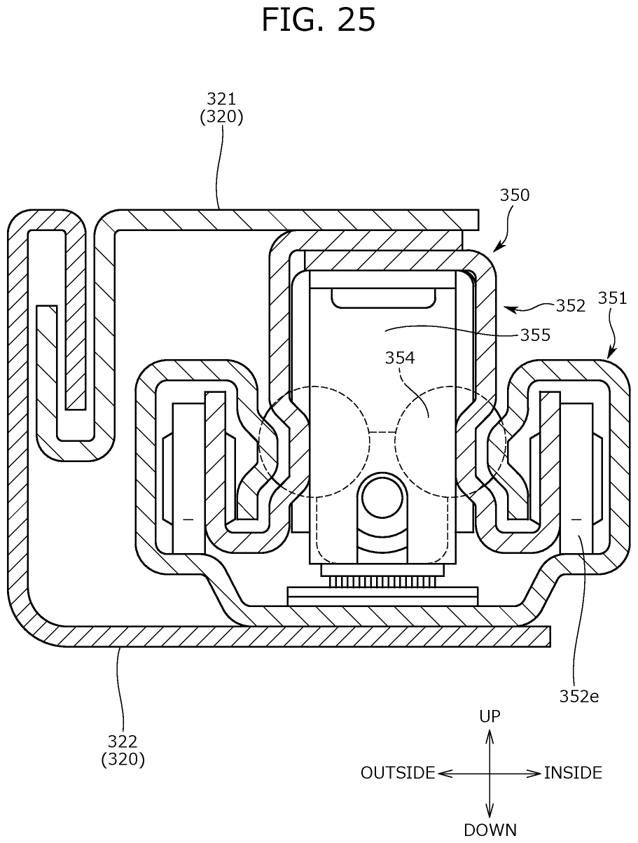

FIG. 23 is a schematic view showing a positional relationship between the slide mechanism 350 and a battery B when viewed from above, and FIG. 24 is a cross-sectional view taken along line XXIV-XXIV of FIG. 23, is a view of the positional relationship between the slide mechanism 350 and the battery B when viewed from the side, and is a view showing a state where upper rails 352 are located on rearmost end sides of the respective lower rails 51.

In electric vehicles and hybrid vehicles, it is desirable to mount more batteries, and in many cases, batteries are provided on the floor of a vehicle. However, in the related art, batteries for an electric vehicle or a hybrid vehicle provided on a floor are disposed while avoiding a slide mechanism, for example, as disclosed in JP 2021-59140 A. For that reason, the floor is expanded in a width direction to mount more batteries thereon. For that reason, there has been a desire for a structure in which batteries, including seats including electric slide mechanisms (slide devices), are compactly disposed as a whole.

As shown in FIG. 24, a floor panel 310 constituting a floor FL of a vehicle such as an electric vehicle includes an upper floor panel 311 and a lower floor panel 312 disposed at a distance from the upper floor panel 311, and the battery B is placed on an upper surface of the lower floor panel 312.

As shown in FIGS. 23 and 24, the slide mechanism 350 of the present embodiment is disposed to overlap the battery B in the up to down direction. By implementing such disposition, a space below the slide mechanism 35 can be effectively utilized, thereby contributing to making the structure of the vehicle more compact in the width direction.

Incidentally, the electric slide mechanism 350 includes lower rails 351 that support the vehicle seat to be movable in the front to rear direction, and the upper rails 352 that move on the respective lower rails 351 in a sliding manner. Each of the upper rails 352 is provided with a motor 355 provided within the range of the upper rail, and worm gears 354 (drive units) rotated by the motor 355.

The upper rail 352 is configured to be movable relative to the lower rail 351. Since a basic configuration of the slide mechanism 350 is the same as the slide mechanism 50 of the first embodiment, a detailed description will be omitted.

As shown in FIG. 24, the lower rail 351 of the slide mechanism 350 is positioned with respect to the upper floor panel 311 by positioning pins 314, and then are fastened and fixed using rail attachment bolts 313. In the related art, when the upper rail is located at a foremost end or a rearmost end of the lower rail, the rail attachment bolts to be fastened are disposed at positions that do not overlap the upper rail in the up to down direction. Namely, the rail attachment bolts are provided at positions in front of or behind the upper rail.

In the present embodiment, as shown in FIG. 24, when the upper rail 352 is at the position of a rearmost end of the slide mechanism 350, the rail attachment bolts 313 are disposed to overlap the upper rail 352 in the up to down direction. Although not shown, even when the upper rail 352 is at the position of a foremost end of the slide mechanism 350, the rail attachment bolts 313 are disposed to overlap the upper rail 352. By disposing the upper rail 352 to overlap the rail attachment bolts 313 even when the upper rail 352 is located at the foremost end or the rearmost end, the slide mechanism 350 can be more compactly configured in the front to rear direction.

### <Separation Suppression Member 320>

A separation suppression member 320 provided in the slide mechanism 350 will be described using FIG. 25. FIG. 25 is a cross-sectional view showing the slide mechanism 350 provided with the separation suppression member 320.

The separation suppression member 320 includes an upper hook member 321 fixed to the upper rail 352, and a lower hook member 322 fixed to the lower rail. As shown in FIG. 25, a side portion of the upper hook member 321 and a side portion of the lower hook member 322 are configured to mesh with each other. In a normal usage state, the upper hook member 321 and the lower hook member 322 do not come into direct contact with each other, and the slide movement thereof is not inhibited by the separation suppression member 320. However, when a large load is applied to the vehicle seat in the event of a traffic accident or the like, the upper hook member 321 meshes with the lower hook member 322 when the upper rail 352 moves upward. Therefore, the separation of the upper rail 352 from the lower rail 351 is suppressed. When the lower hook member 322 is provided over the entirety of the lower rail 351 in the front to rear direction, the separation of the upper rail 352 can be suppressed no matter where the upper rail 352 is located in the front to rear direction.

### <Movement Restriction of Upper Rail 352>

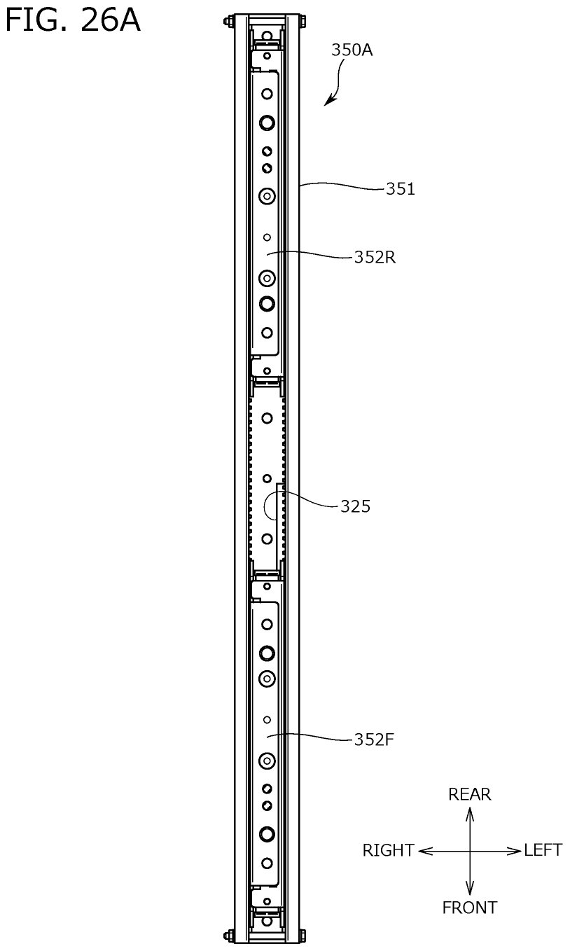

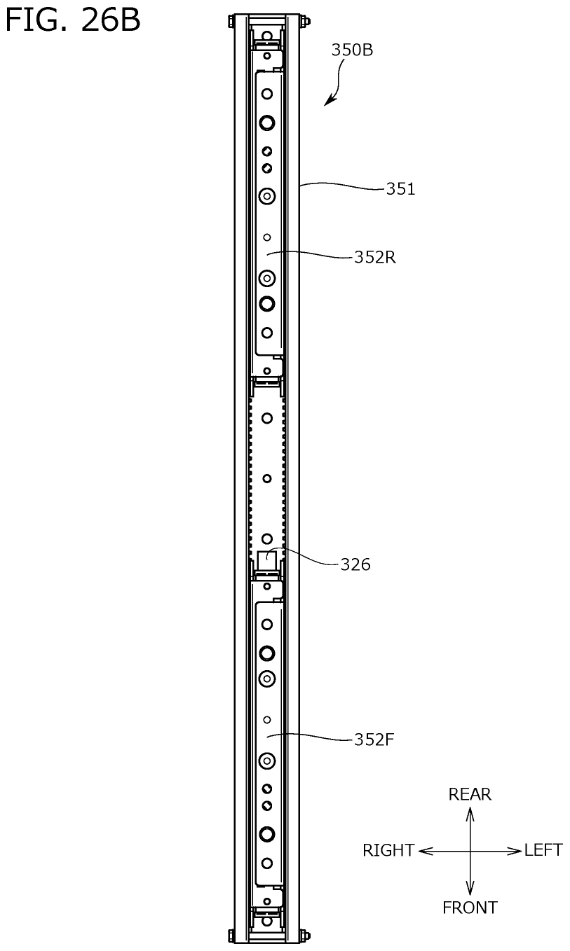

Means for restricting movement of the upper rail 352 will be described using FIG. 26. Depending on the vehicle, the floor FL may be provided with a long rail extending long in the front to rear direction. In the long rail, the lower rail 351 used by a front seat FS and a rear seat RS is shared, and an upper rail 352F of the front seat FS and an upper rail 352R of the rear seat RS are configured to move on the shared lower rail 351 in a sliding manner.

When such a long rail is used, it is necessary to maintain an appropriate distance between the front seat FS and the rear seat RS. Particularly, when the front seat FS is electrically moved, it is desirable to suppress the approach of the front seat FS to the rear seat RS.

FIG. 26A is a top view showing a slide mechanism 350A provided with a stopper 325, and FIG. 26B is a top view showing a slide mechanism 350B provided with an another seat position detection sensor 326.

In the present embodiment, as shown in FIG. 26A, in order to maintain the distance between the front and rear seats, the stopper 325 is disposed on the lower rail 351 of the long rail. The stopper 325 is a plate-shaped member, and is disposed between the upper rail 352F of the front seat FS and the upper rail 352R of the rear seat RS. When the upper rail 352F is moved rearward, the upper rail 352F comes into contact with the stopper 325, so that the movement thereof on the long rail is restricted. In addition, even when the upper rail 352R of the rear seat RS is moved forward, the upper rail 352R comes into contact with the stopper 325, so that the movement thereof is restricted. By disposing the stopper 325, the movement of the upper rails 352F and 352R is restricted, so that the distance between the front and rear seats can be maintained.

In addition, when the upper rail 352F is electrically operated, as shown in FIG. 26B, the other seat position detection sensor 326 that detects a position of another upper rail 352 may be provided at a rear end of the upper rail 352F of the front seat FS and/or a front end of the upper rail 352R of the rear seat RS. The other seat position detection sensor 326 is formed of, for example, an infrared sensor or a LiDAR sensor. By detecting the position of another seat, when the distance to the other seat becomes shorter than a predetermined distance, the upper rail 352 can be controlled to be immovable. Accordingly, the distance between the seats lined up in the front and rear can be maintained without providing the stopper 325.

Incidentally, the installation position of the other seat position detection sensor 326 is not limited to the upper rail 352, and the other seat position detection sensor 326 may be provided in the seat back or the seat cushion of the vehicle seat. However, since the detected distance changes depending on the presence or absence of a seated occupant, it is desirable to attach the other seat position detection sensor 326 to the upper rail 352.

In addition, the upper rail 352 may be operated manually or electrically. The slide mechanisms 350A and 350B shown in FIGS. 26A and 26B are configured such that the upper rail 352F of the front seat FS is electrically moved and the upper rail 352R of the rear seat RS is manually moved; however, the upper rail 352F of the front seat FS may be manually operated and the upper rail 352R of the rear seat RS may be electrically operated. Both the upper rails 352F and 352R of the front seat FS and the rear seat RS may be electrically operated.

### <Positional Relationship Between Slide Mechanism 350 and Battery B>

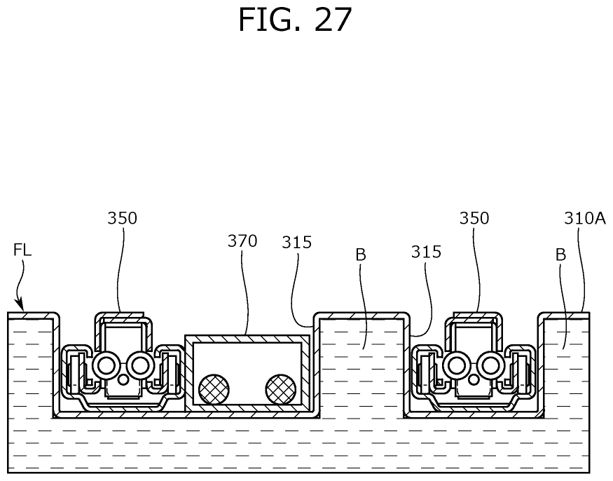

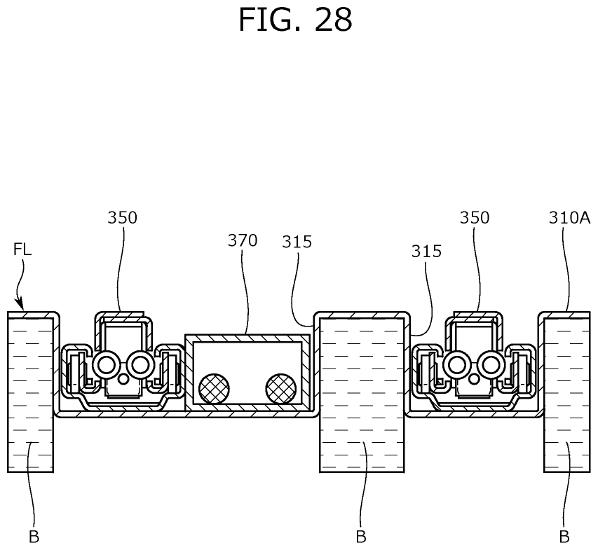

A positional relationship between the slide mechanism 350 and the battery B will be described using FIGS. 27 and 28. As described above, it is desirable to mount more batteries B in an electric vehicle.

As shown in FIG. 27, groove portions 315 are formed along the respective slide mechanisms 350 on a floor panel 310A constituting the floor FL of the present embodiment, and the slide mechanisms 350 are configured to be accommodatable in the respective groove portions 315. When a cable casing 370 (excess cable length accommodating unit) in which a cable for an electric power supply rail is accommodated is provided along the slide mechanism 350, the groove portion 315 capable of accommodating the slide mechanism 350, also including the cable casing 370, is formed.

When a plurality of the groove portions 315 are formed in parallel on the floor panel 310A of the vehicle body floor FL, a space is formed between the groove portions 315 adjacent to each other. When the batteries B are disposed using this space, more batteries B can be mounted. Incidentally, as shown in FIG. 28, the battery B may be divided to be disposed between the groove portions 315.

### <Means for Fixing Slide Mechanism 350>

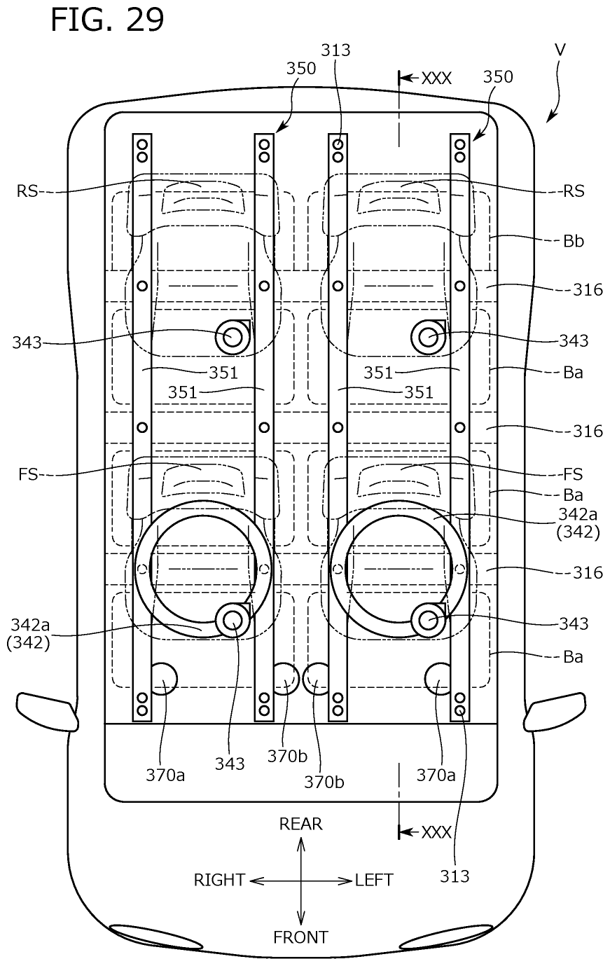

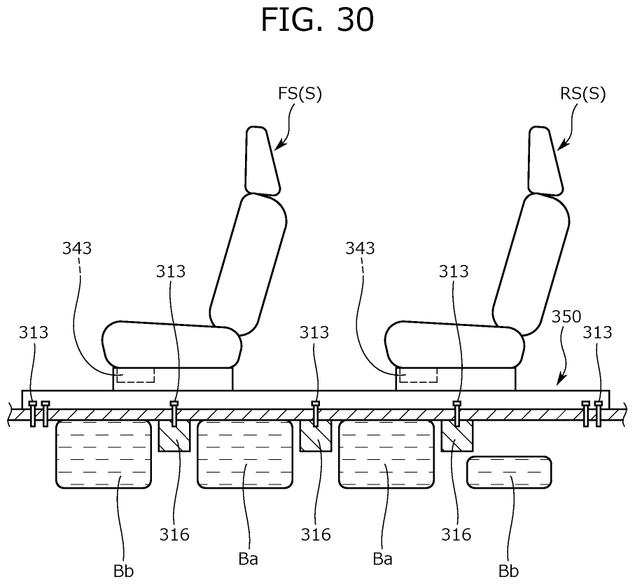

Means for fixing the slide mechanism 350 to the vehicle body floor will be described using FIGS. 29 and 30. FIG. 29 is a top view showing a positional relationship between the slide mechanisms 350 and the vehicle V, and FIG. 30 is a cross-sectional view taken along line XXX-XXX of FIG. 29. In the case of an electric vehicle, a plurality of member frames 316 extending in the width direction of the vehicle V are provided on the vehicle body floor FL. The batteries B are disposed below the vehicle body floor FL. The battery B is disposed between the member frames 316 as in the case of a battery Ba shown in FIG. 30. In addition, as in the case of a battery Bb shown in FIG. 30, the battery B may be disposed to overlap the member frame 316 in the height direction. In other words, a part of the battery Bb may be located below the member frame 316.

The slide mechanism 350 is disposed to extend in the front to rear direction of the vehicle V. The rail attachment bolts 313 are used to fix the lower rails 351 of the slide mechanism 350 to the floor FL, and the rail attachment bolts 313 are disposed on the member frames 316 to be fixed to the member frames 316. By locating the rail attachment bolts 313 on the member frames 316 and by fixing the lower rails 351 to the floor FL, the slide mechanism 350 can be more firmly attached.

### <Cable Casing 370>

The position of the cable casing 370 provided in the slide mechanism 350 will be described using FIG. 29. In the slide mechanism 350, a cable for supplying electric power to the vehicle seat S is disposed at a side portion of the lower rail 351, and the cable casing 370 (excess cable length accommodating unit) that accommodates the cable is provided. It is preferable that the cable casing 370 is disposed inside a pair of the lower rails 351 constituting the slide mechanism 350 as in the case of a cable casing 370a shown in FIG. 29.

In addition, as in the case of a cable casing 370b shown in FIG. 29, the cable casing 370 may be disposed outside the lower rails 351, and in this case, the cable casing 370 is disposed between the slide mechanisms 350 mounted in the vehicle V and disposed on the right and left.

By disposing the cable casing 370 in such a manner, a space between the lower rails 351 of the slide mechanism 350 can be effectively utilized.

In addition, when the vehicle seat S is an air-conditioned seat including an air blower device, a blower 343 that blows out air may be provided under the seat cushion. It is preferable that the blower 343 is disposed between a pair of the lower rails 351. By disposing the blower 343 inside the slide mechanism 350, it is possible to prevent the position of the vehicle seat S from becoming higher.

In addition, when the vehicle seat S is a rotary seat that is rotatable about an axis extending in the up to down direction, a seat rotating member 342 that rotates the seat body may be provided to partially overlap the slide mechanism 350 as in the case of a seat rotating member 342a of FIG. 29.

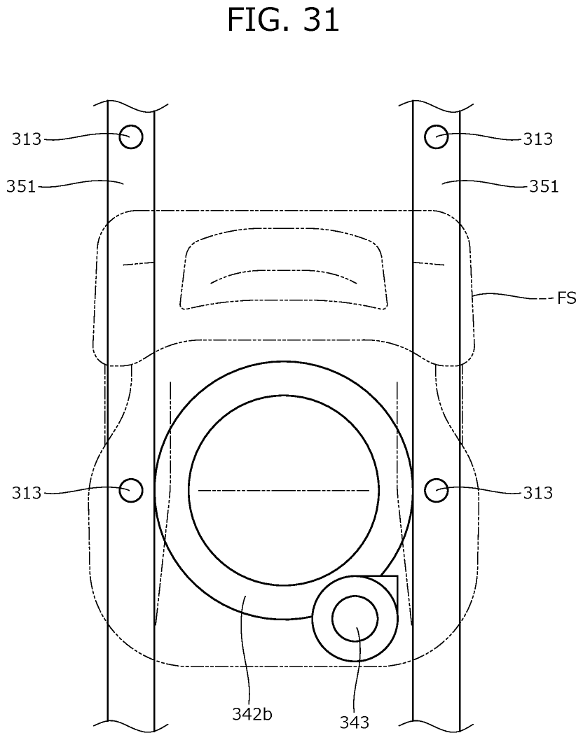

In addition, an outer end portion of the seat rotating member 342 may be disposed inside the slide mechanism 350, namely, between a pair of the lower rails 351 as in the case of a seat rotating member 342b shown in FIG. 31. By disposing the seat rotating member 342b inside the slide mechanism 350, the vehicle seat S can be more compactly configured.

In addition, it is preferable that the blower 343 is disposed to partially overlap the seat rotating member 342 in the up to down direction. By disposing the blower 343 in such a manner, the vehicle seat S can be more compactly configured in the front to rear direction.

### <Motor Support Member 356>

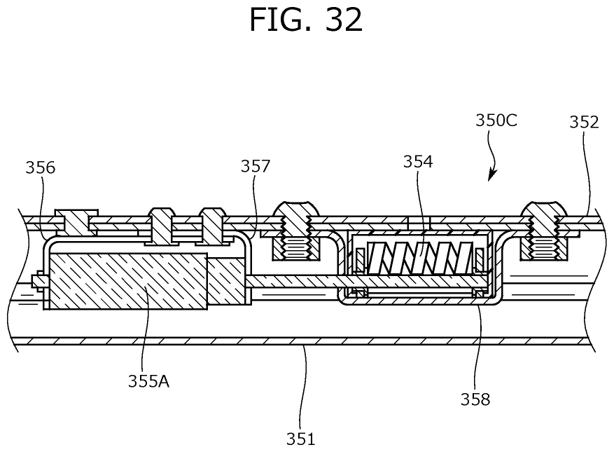

A slide mechanism 350C including a motor support member 356 will be described using FIG. 32. The slide mechanism 350C is electrically operated, and as described above, the upper rail 352 is provided with a motor 355 and the worm gear 354 that is rotationally driven by the motor 355. The motor 355 of the slide mechanism 350 shown in FIG. 24 is fixed by an attachment member 357 that is cantilevered; however, the motor support member 356 having an L-shaped cross section is further attached to an end portion of the motor 355A of the upper rail 352 shown in FIG. 32, the end portion being opposite to an end portion of the motor 355A connected to the worm gears 354. Since both end portions of the motor 355A are fixed by the attachment member 357 and the motor support member 356, the motor 355A is less likely to come off from the upper rail 352, and coming-off is suppressed.

### <Sound Insulation Cover 380>

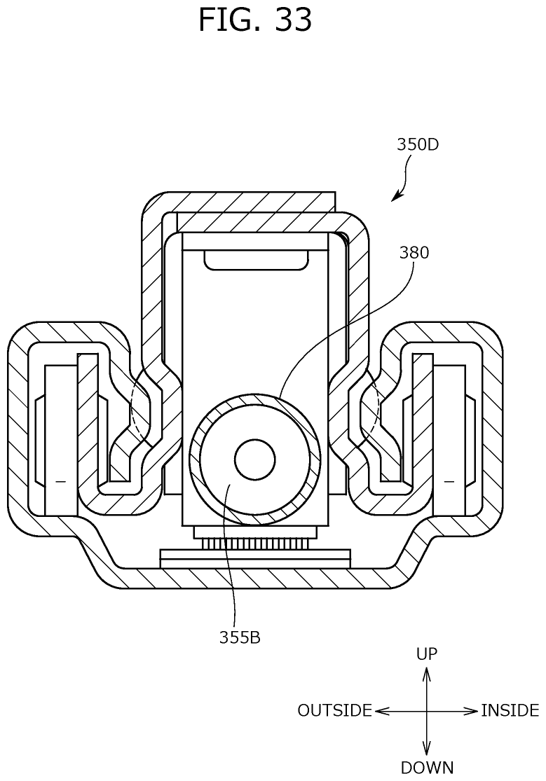

A sound insulation cover 380 provided in a slide mechanism 350D will be described using FIG. 33. FIG. 33 is a cross-sectional view of the slide mechanism 350D to which the sound insulation cover 380 is attached. As shown in FIG. 33, the sound insulation cover 380 is provided to surround a motor 355B. The sound insulation cover 380 is made of resin or metal. The sound insulation cover 380 may be made of fabric. By providing the sound insulation cover 380 around the motor 355B, leakage of motor sound to the outside can be suppressed, and discomfort caused by noise during sliding can be suppressed.

### <Gear Cover 382>

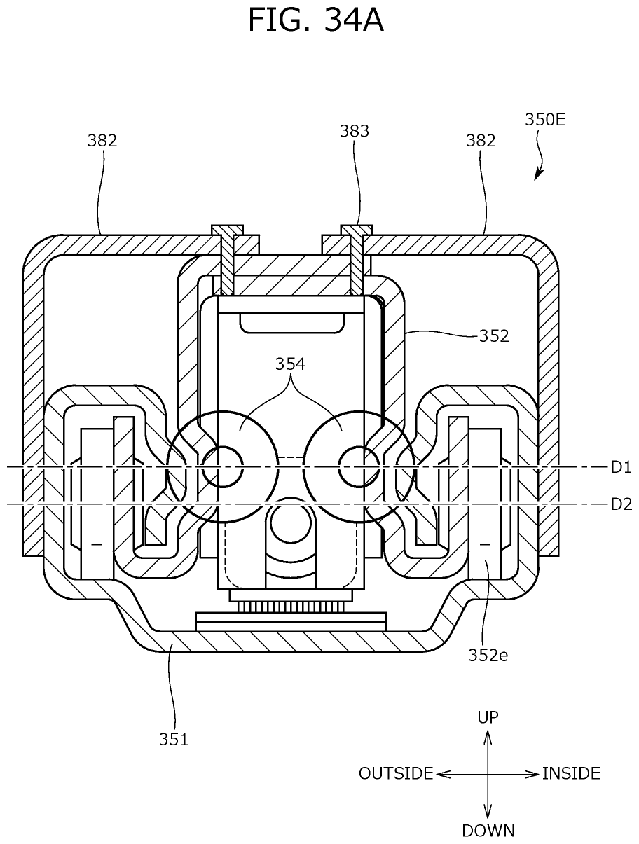

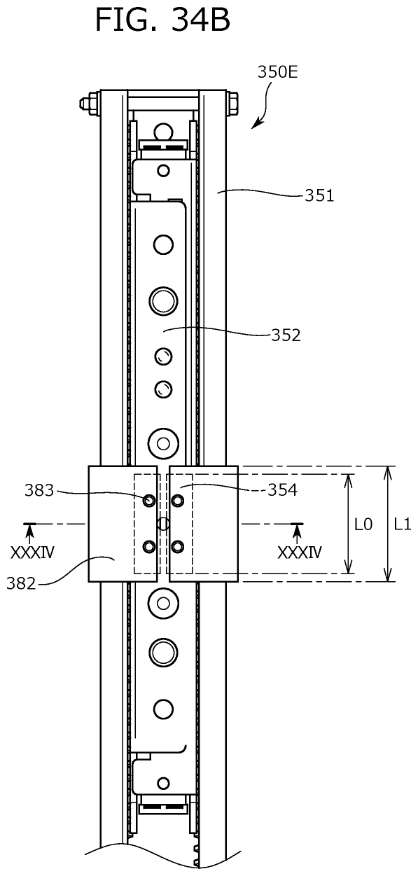

A gear cover 382 provided in a slide mechanism 350E will be described using FIGS. 34A and 34B. FIG. 34A is a cross-sectional view of the slide mechanism 350E to which the gear cover 382 is attached, and FIG. 34B is a top view of the slide mechanism 350E to which the gear cover 382 is attached. The gear cover 382 is formed of a member having a cross section formed in an L shape, and an upper end thereof is fixed to an upper end portion of the upper rail 352 by a fastening member 383 such as a bolt.

A lower end portion of the gear cover 382 is formed to be located below an imaginary line D1 connecting rotation axes of two worm gears 354 disposed on the right and left. In addition, the lower end portion of the gear cover 382 is formed to be located below an imaginary line D2 connecting rotation axes of two rollers 352e disposed on the right and left.

In addition, a length L1 of the gear cover 382 in the front to rear direction is formed to be longer than a length L0 of each worm gear 354 in the front to rear direction which is provided on the upper rail 352. By providing the gear cover 382 formed in such a manner, the entry of dirt, dust, or the like into the worm gears 354 is suppressed. In addition, leakage of sound, which is generated during the rotation of the worm gears 354, to the outside is suppressed.

### <Lock Device 367>

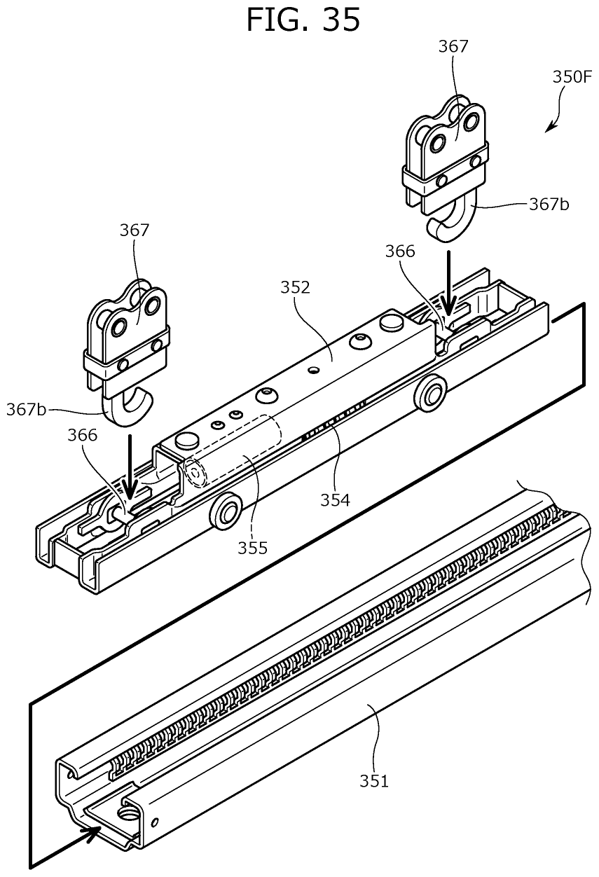

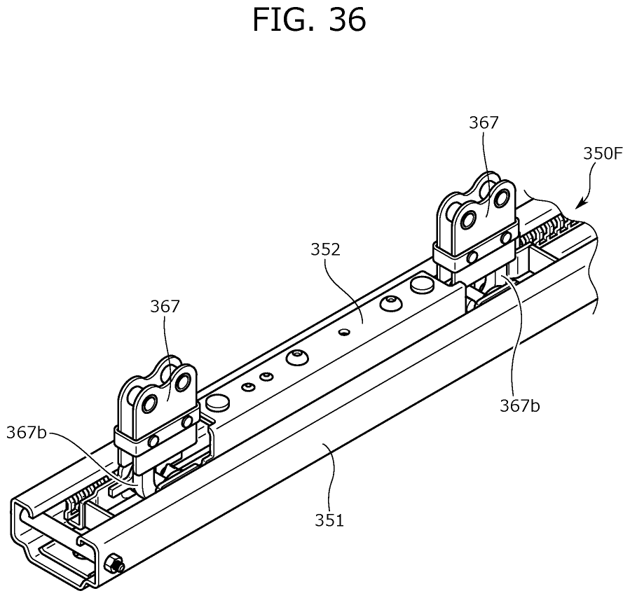

Lock devices 367 provided in a slide mechanism 350F will be described using FIGS. 35 and 36. The seat body (the seat cushion and the seat back) of the vehicle seat S includes the lock devices 367 similar to the lock device 67 provided in the vehicle seat S of the first embodiment, and the lock devices 367 may be configured to be attachable to and detachable from the slide mechanism 350F. As shown in FIG. 35, each lock device 367 is provided with a latch 367b that is rotatable.

In the slide mechanism 350F, strikers 366 that engage with the latches 357b are provided at the front and rear of the upper rail 352.

The latches 357b of the lock devices 367 are provided on the seat body of the vehicle seat S, and by unlocking the latches 357b using operation means (not shown), the vehicle seat body can be removed from the slide mechanism 350F.

The latches 367b are disposed at positions overlapping the worm gears 354 in the height direction when the vehicle seat is attached to the upper rail 352. In addition, the latches 367b may be disposed not to overlap the worm gears 354 in the height direction.

In addition, the latches 367b are disposed at positions overlapping the motor 355 in the height direction when the seat body is attached. The latches 357b may be disposed not to overlap the motor 355 in the height direction.

### <Positional Relationship Between Cable Casing 370 and Blower 343>

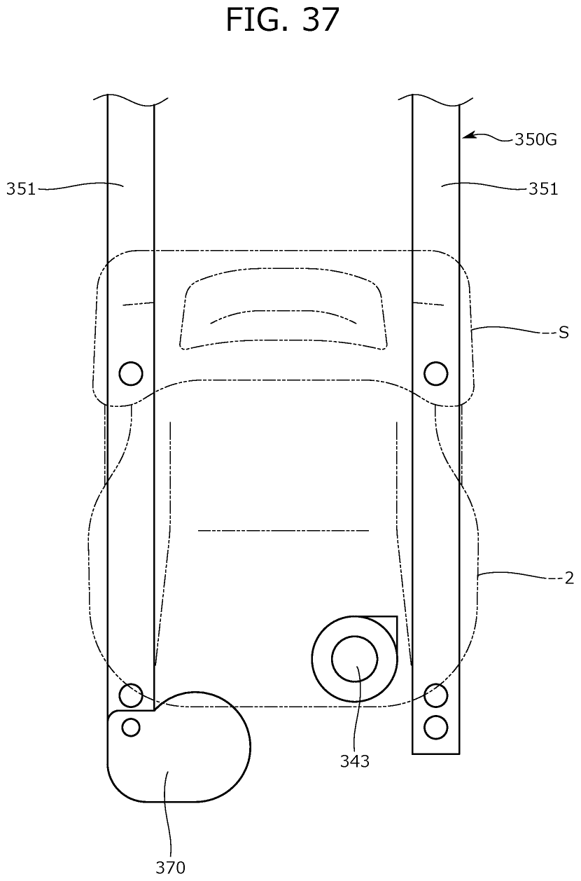

A positional relationship between the cable casing 370 (excess cable length accommodating unit) provided in a slide mechanism 350G and the blower 343 for an air-conditioned seat will be described using FIG. 37.

FIG. 37 is a schematic view of the slide mechanism 350G provided with the cable casing 370 and the vehicle seat S located at the forefront of the slide mechanism 350G when viewed from above.

As shown in FIG. 37, the vehicle seat S is configured such that when the vehicle seat S is at the foremost position of the slide mechanism 350, a distal end portion of the seat cushion 2 overlaps the cable casing 370 in the up to down direction.

In addition, when the vehicle seat S is an air-conditioned seat including an air blower device, it is preferable that the blower 343 of the air blower device is disposed on a side opposite to the cable casing 370. By disposing the blower 343 at a position far from the cable casing 370, even when the vehicle seat S is disposed at the foremost position of the slide mechanism 350, there is no risk that the cable casing 370 and the blower 343 come into contact with each other. Therefore, an occupant can move the vehicle seat S to the foremost position of the slide mechanism 350 without worrying about contact between the cable casing 370 and the blower 343.

The embodiments of the present invention have been described above with reference to the drawings. The present invention may be applied not only to ground traveling conveyances including wheels, such as automobiles and railways, and vehicle seats mounted therein, but also to aircrafts or ships that move other than on the ground, and seats mounted therein.

### REFERENCE SIGNS LIST

### First Embodiment

S, SA: vehicle seat (conveyance seat)
DR: door
WD: window
Sh: seat body
F: seat frame
Tr: trim cover
P: cushion pad
1: seat back
2: seat cushion
3: headrest
5: power supply
6: operation switch (operation unit)
7: rotation lever (operation unit)
10: seat back frame
11: upper frame
12: lower frame
13: back side frame
14: headrest guide
20: seat cushion frame
21: cushion side frame
22: front connecting frame
23: rear connecting frame
24: cushion pan frame
25: S spring
28: reclining cover
30: headrest frame
31: pillar portion
40: rotation mechanism
41: base member
42: rotating member
43: cover member
44: rotation drive device
45: actuator
46: output gear
47: input gear
48: rotation support portion
49: bearing
49a: ball
49b: annular recess
C: rotation axis
D: circumferential line
50, 50A: slide mechanism
51, 51′: lower rail
51a: rail inner wall
52, 52′: upper rail
52A: first piece
52B: second piece
52a: base portion
52b: slider inner wall
52c: slider lower wall
52d: slider outer wall
52e: wheel
53: screw assembly
54: worm gear
55: motor
57: screw engagement portion
58: gear casing
59: first bracket
60: second bracket
61: electric power supply device
62: electricity transmitter
63: electricity receiver
64: conductive strip
65: electrical insulating plate
66: striker
67: lock device
67a: hook
67b: latch
68: bolt
70: reclining mechanism
71: motor
80: ECU (control unit)
81: processor
82: memory
83: input/output interface
t1, t3: transition start time
t2, t4: predicted transition completion time
Et1, Et2: movement time
90: lateral slide mechanism
91: lower rail
92: upper rail
93: attachment bracket

### Second Embodiment

V: vehicle
S1: driver seat
S2: front passenger seat
S3, S4: rear seat
S5: center seat
FL: vehicle body floor
FW: front wheel
RW: rear wheel
WH: wheel house
201, 201A to 201C: first slide mechanism
202, 202A to 202C: second slide mechanism
211: lower rail
211b: recessed portion
212: upper rail
213: worm gear
213a: upper end
213b: lower end
214: motor
214a: upper end
214b: lower end
215: electricity receiver
216A: electricity transmitter
216B: electricity transmitter
220: first electric power supply device
221: first cable casing
221a: upper end
221b: lower end
222: electric power supply cable
222a: upper end
222b: lower end
230: second electric power supply device
231: second cable casing
231a: upper end
231b: lower end
232: guide plate
232a: upper end
232b: lower end
233: flexible flat cable
233b: lower end
234: rail
235: actuator

### Third Embodiment

V: vehicle
B, Ba, Bb: battery
FL: vehicle body floor
S: vehicle seat
FS: front seat
RS: rear seat
310, 310A: floor panel
311: upper floor panel
312: lower floor panel
313: rail attachment bolt
314: positioning pin
315: groove portion
316: member frame
320: separation suppression member
321: upper hook member
322: lower hook member
325: stopper
326: another seat position detection sensor
342: seat rotating member
343: blower
350, 350A to 350G: slide mechanism
351: lower rail
352: upper rail
352e: roller (wheel)
354: worm gear
355, 355A: motor
356: motor support member
357: attachment member
366: striker
367: lock device
367b: latch
370: cable casing (excess cable length accommodating unit)
380: sound insulation cover
382: gear cover
383: fastening member

1. A conveyance seat, comprising:
a seat body in which an occupant is seated;
a slide mechanism that moves the seat body in a sliding manner;
a rotation mechanism that rotationally moves the seat body with an up to down direction as a rotation axis;
a control unit that controls an operation of the slide mechanism and the rotation mechanism; and
an operation unit that instructs the control unit to start control,
wherein when the control unit receives an instruction from the operation unit, the control unit sets a transition start time of each of the slide mechanism and the rotation mechanism.

2. The conveyance seat according to claim 1,
wherein the control unit is capable of causing each of the slide mechanism and the rotation mechanism to transition from a current state to a target state, and
when the control unit receives the instruction from the operation unit, the control unit causes one of the slide mechanism and the rotation mechanism to start transitioning, and causes the other mechanism to start transitioning before the transition of the one mechanism is completed.

3. The conveyance seat according to claim 2,
wherein the control unit receives the instruction from the operation unit, the control unit calculates a predicted transition completion time for each of the slide mechanism and the rotation mechanism to transition from the current state to the target state, and sets the transition start time of the other mechanism to a time before the predicted transition completion time of the one mechanism.

4. The conveyance seat according to claim 1,
wherein when the control unit receives the instruction from the operation unit, the control unit causes one of the slide mechanism and the rotation mechanism to start transitioning, and causes the other mechanism to start transitioning after the transition of the one mechanism is completed.

5. The conveyance seat according to claim 1,
wherein when the control unit receives the instruction from the operation unit, a transition of the slide mechanism and a transition of the rotation mechanism are started at the same time.

6. The conveyance seat according to claim 1,
wherein the operation unit is a rotation lever, and
when a rotation angle of the rotation lever is less than a predetermined angle, the control unit causes the slide mechanism to start transitioning, and when the rotation angle is greater than or equal to the predetermined angle, the control unit causes both the slide mechanism and the rotation mechanism to start transitioning.
